(19) United States
(12) Patent Application Publication
(10) Pub. No.: US 2026/0356015 A1
(43) Pub. Date: Nov. 12, 2026

(54) MOULD AND METHOD FOR MAKING A CAP FOR A CONTAINER

(71) Applicant: SACMI COOPERATIVA MECCANICI IMOLA SOCIETA' COOPERATIVA, IMOLA (BOLOGNA) (IT)

(72) Inventors: PIERO MARETTI, IMOLA (BOLOGNA) (IT); ROBERTO MONDINI, IMOLA (BOLOGNA) (IT)

(21) Appl. No.: 19/111,932

(22) PCT Filed: Sep. 15, 2023
(86) PCT No.: PCT/IB2023/059191

§ 371 Date: Mar. 14, 2025

(30) Foreign Application Priority Data
Sep. 16, 2022 (IT) 102022000019038

(51) Int. Cl. B29C 43/36; B29C 43/52; B29L 31/56

(52) U.S. Cl. CPC B29C 43/361; B29C 43/52; B29C 2043/3615; B29L 2031/565

(57) ABSTRACT

A mould for making a cap includes: a lower half mould, including a body and a plunger, movable relative to the body between a retracted position and an advanced position; an upper half mould, where the lower half mould and the upper half mould are reciprocally movable along a longitudinal axis between an open position and a closed position of the mould, where they delimit the moulding space; a drawer, movable along a radial direction relative to the longitudinal axis, between a retracted position, distal to the moulding space, and a closed position, proximal to the moulding space, and including a head surface which, at the closed position of the drawer, contributes to delimiting the moulding space; a movement system configured to move the drawer along the radial direction from the retracted position to the closed position responsive to the upper half mould and the lower half mould moving closer to each other.

### TECHNICAL FIELD

This invention relates to a mould for making a cap for a container. The invention also relates to a method for making a cap for a container. In particular, the technical sector regards a mould used for making a cap for a container by compressing a dose of material in a moulding space.

### BACKGROUND ART

Conventionally, known in the prior art are caps comprising a body and a tamper evident ring, where the body is connected to the tamper evident ring by a connecting tear strip; more specifically, when a user twists the cap for the first time, the body is separated from the tamper evident ring and the tamper evident ring remains attached to the neck of the container. In other types of caps, a permanent connecting zone of the tear strip does not tear and keeps the cap body attached to the tamper evident ring, thus preventing the body of the cap from being lost and littering the environment. These caps are known as “tethered” caps.

Both in traditional caps and in tethered caps, the connecting tear strip may include holes (or windows) and/or recesses (or films), that is to say, narrow thickness portions of the cap. Both the holes and the recesses may be made in a mould, for example, using movable drawers. An example of these moulds is described in patent document 102019000022992, in the name of the present Applicant, where the dose is squeezed by means of a barrel, while a drawer makes a hole in the side wall of the cap. That document does not, however, exhaustively describe how the movement of the drawer is accomplished.

Another example is described in patent document 102021000006557, in the name of the present Applicant, where a contoured portion of the drawer interacts with a contoured portion of the upper or lower half mould so that when the half moulds moves closer together to compress the dose, the drawer moves transversely closer to the side wall of the cap. This solution however, is not flexible (it is not possible to make through holes and reduced thickness zones using the same mould). Moreover, the two contoured portions tend to rub against each other, so the does not close properly.

### DISCLOSURE OF THE INVENTION

This disclosure has for an aim to provide a mould and a method for making a cap for a container to overcome the above mentioned disadvantages of the prior art.

More specifically, the aim of this invention is to provide a mould and a method for making a cap for a container where the movements between the components of the mould are performed in a mechanically robust manner.

A further aim of this invention is to provide a mould capable of making caps comprising through holes or narrow films using the same mould.

Another aim of this invention is to propose a mould which, when moulding has been completed, allows the cap to be extracted without damaging it.

This aim is fully achieved by the mould and the method of this disclosure for making a cap for a container as characterized in the appended claims.

This disclosure relates to a cap for a container. More specifically, this disclosure relates to a plastic cap for containers such as bottles for water or other beverages, oil containers or containers for non-food liquids (such as liquid soaps or detergents). This disclosure might, however, also be applicable to caps made from different materials such as metals, for example.

This disclosure regards a mould used for making a cap for a container by compressing a dose of material in a moulding space; this disclosure, however, might also apply to the moulding of a dose of material in a moulding space by injection or by injection and compression.

In an example, the cap comprises a side wall (or skirt) which extends around a main axis between a first and a second end, and a transverse wall, oriented transversely to the main axis and connected to the side wall at the second end of the side wall.

More specifically, the mould comprises a lower half mould (that is, a female mould) and an upper half mould (that is, a male mould). The lower half mould and the upper half mould are reciprocally movable along a longitudinal axis between an open position of the mould (that is, a spaced-apart position, to define an open position of the mould) and a closed position (that is a close-together position, to define a closed position of the mould). Preferably, at the closed position of the mould, the upper half mould and the lower half mould delimit the moulding space.

Preferably, the lower half mould (or the upper half mould) includes a body. The lower half mould may comprise a plunger (also called “syringe” or “barrel”). The body and the plunger may be reciprocally movable. More specifically, the plunger is movable relative to the body between a retracted position, where it acts in conjunction with the body to form a recess configured to receive the dose, and an advanced position, where it at least partly occupies the recess. Preferably, the recess is open onto the moulding space. In an example, the plunger can be configured to move with respect to the body or, more preferably, the body can be configured to move with respect to the plunger, so that the plunger, relative to the body, moves between a retracted position, where it acts in conjunction with the body to form a recess, and an advanced position, where it at least partly occupies the recess. The mould comprises a drawer. The drawer is movable between a retracted position, distal to the moulding space, and a closed position, proximal to the moulding space. The drawer may be movable along a direction of movement substantially parallel to the longitudinal direction or coinciding with the longitudinal direction or, more preferably, along a radial direction with respect to the longitudinal axis (that is, a direction incident upon, or transverse to, the longitudinal axis). In other words, the drawer may be movable towards the longitudinal axis.

In an example, the drawer includes a head surface which contributes to delimiting the moulding space, preferably when the drawer is at the closed position. The head surface may be configured to externally delimit a recess or narrow thickness zone or film of the cap (or rather, of the side wall or transverse wall of the cap). The head surface may be configured to be surrounded by the plastic to create a through hole made in the side wall or in the transverse wall of the cap. In that case, the drawer (or the head surface), when it is at the closed position, close to the moulding space, defines a break zone, that is to say, a zone of the moulding space where there is an interruption to the flow of plastic.

The mould comprises a movement system configured to move the drawer, preferably along the radial direction. The movement system is configured to move the drawer from the retracted position to the closed position, preferably responsive to the upper half mould and the lower half mould moving closer to each other. In other words, the closing movement of the drawer towards the moulding space is synchronized with the movement of the upper half mould and the lower half mould towards each other. The closing movement of the drawer and the movement of the upper half mould and the lower half mould towards each other may, for example, be synchronized by mechanical or electrical means. Preferably, the drawer reaches the closed position before the mould reaches the closed position. It is noted that this invention may be carried out even without the plunger. The plunger has the advantage of making it possible to decide the moment when compression of the cap inside the moulding space must stop.

In an embodiment, the movement system includes a cam and a wheel configured to interact with the cam, preferably to move the drawer. The movement system may include a driving structure. The driving structure and the drawer may be reciprocally movable along the longitudinal axis. Preferably, the driving structure is movable longitudinally. Alternatively, the driving structure is fixed longitudinally.

In an example, the cam is attached to the drawer and the wheel is connected to the driving structure. In another example, the wheel is connected to the drawer and the cam is attached to the driving structure.

In an embodiment, the movement system includes a first contoured surface and a second, complementary contoured surface matching the first, configured to interact with each other so as to move the drawer. In this case, the first contoured surface may be attached to the drawer and the second, complementary contoured surface may be attached to the driving structure, or vice versa.

The drawer may be located in (associated with) the lower half mould or the upper half mould. The driving structure may be located in the lower half mould or the upper half mould. When the driving structure is in the lower half mould, the driving structure can be fixed (directly or indirectly) to the plunger, so that the body is configured to move along the longitudinal direction with respect to the driving structure and to the plunger.

In an example, the lower half mould comprises a base. Preferably, the base is fixed along the longitudinal axis. In particular, the plunger can be fixed to the base so that the plunger, together with the base, is fixed along the longitudinal axis, while the body is movable along the longitudinal direction. The lower half mould can comprise a first locking key, to lock the angular position around the longitudinal axis of the plunger with respect to the base. The lower half mould can comprise a second locking key, to lock the angular position around the longitudinal axis of the body with respect to the plunger. The second locking key is configured to angularly lock the body to the plunger, while allowing the body to move along the longitudinal axis.

In an example, the lower half mould comprises a hollow cylinder. When the driving structure is in (associated with) the lower half mould, the hollow cylinder can define the driving structure. The hollow cylinder develops cylindrically around the longitudinal axis. The hollow cylinder can be placed externally (surround) the plunger and the body. In an example, the lower half mould comprises a base. The base can be fixed along the longitudinal axis. The plunger can be fixed to the base. Preferably, the hollow cylinder is fixed to the plunger so that the hollow cylinder, together with the plunger (and the base), and the body translate reciprocally along the longitudinal axis. In particular, the hollow cylinder is connected to the plunger and the body moves along the longitudinal axis while the hollow cylinder, together with the plunger (and the base), is fixed along the longitudinal axis.

For example, the lower half mould can comprise a ring. The ring develops annularly around the longitudinal axis. The hollow cylinder can develop longitudinally from a lower to an upper extreme. Preferably, the ring is fixed to the upper extreme of the hollow cylinder, for example through one or more locking screw. In particular, the ring can comprise one or more eyeholes configured to be coupled to one or more corresponding holes provided in the upper extreme of the hollow cylinder, through one or more corresponding locking screw. Preferably, the one or more eyeholes of the ring extend angularly around the longitudinal axis, so that the ring and the hollow cylinder can be fixed together with a predetermined angular position.

In an example, lower half mould comprises a wheel holder. The wheel can be configured to run (or roll) on the cam, so to move the drawer in a radial direction, preferably responsive to the relative movement between the upper and the lower half mould.

In particular, the wheel holder is connected to the ring. The ring includes a wheel holder seat, configured to house the wheel holder. In particular, the wheel holder has one or more eyeholes, configured to engage with one or more holes of the ring through a one or more corresponding fixing screw, so to fix the wheel holder to the ring (more in particular, to the seat of the ring). Preferably, the one or more eyeholes of the wheel holder develop in one or more corresponding radial directions. Hence, it is possible to fix the wheel holder in a predetermined distance along the radial direction, so to change the distance of wheel with respect to the drawer.

In an example, the ring and the hollow cylinder constitute separate components, in another example, the ring is integrated in the hollow cylinder. Hence, the wheel holder can be fixed to the hollow cylinder, in case the ring is integrated to the hollow cylinder, or to the ring, in case the ring and the hollow cylinder constitutes separate components.

The wheel holder is angularly fixed to the ring (or hollow cylinder) so to align the wheel to the cam, so that the wheel runs or roll on the cam to move the drawer in the radial direction. Hence, the seat for the wheel holder can be provided in the hollow cylinder.

In an example, the drawer is associated to the body of the lower half mould and the cam is provided on a rear surface of the drawer (in other words, the drawer comprises a rear surface that defines the cam of the movement system). Preferably, in the relative movement of the body and the plunger along the longitudinal direction, the wheel rolls on the rear surface of the drawer so that the wheel and the drawer move reciprocally in the radial direction (in particular, the drawer moves in the radial direction). In particular, the body moves along the longitudinal direction with respect to the plunger, and the wheel (connected to the wheel holder that is connected to the hollow cylinder directly or indirectly) pushes the drawer towards the closed position.

In an example, the drawer comprises a head surface. The head surface is opposite to the rear surface. Preferably, the head surface develops symmetrically with respect to an axis that is parallel to the longitudinal axis. The head surface may develop in symmetrical shape, in particular in a semi-circular shape around the longitudinal axis. Preferably, the drawer, that is the head surface, presents a width along a direction perpendicular to the longitudinal axis that is smaller than a diameter of the cap. In the movement between the retracted position and the closed position, the drawer is configured to move along a radial direction so that each point of the head surface moves along a direction that intersects the longitudinal axis (i.e. each point of the head surface moves along a radial direction). In particular, in the movement between the retracted position and the closed position, the centre of mass (or centre of gravity) of the drawer is configured to move along an axis (that is the radial direction) that intersects the longitudinal axis; in other words, the centre of mass (or centre of gravity) of the drawer is configured to move along the radial direction.

The lower half mould defines a lateral portion of the moulding space. The lateral portion is configured to form the (external surface of the) side wall of the cap. The drawer can contribute, along with the lower half mould to delimit the moulding space (in particular, to delimit the lateral portion of the moulding space that is configured to form the side wall of the cap). The lower half mould can be configured to define the external surface of the side wall of the cap, while the drawer is configured to determine recess or narrow thickness zone on the side wall of the cap.

Preferably, the portion of the lower half mould that is configured to form the external surface of the side wall of the cap is stationary along the radial direction (with respect to the drawer which moves along the radial direction).

In an example, the body of the lower half mould comprises a longitudinal surface. The longitudinal surface contributes to delimiting the moulding space. In particular, the longitudinal surface contributes to delimiting a lateral surface or lateral space (or longitudinal surface or longitudinal space) of the moulding space. In particular, the longitudinal surface contributes to forming the (external surface of the) side wall of the cap. The drawer (in particular, the head surface of the drawer) can contribute, along with longitudinal surface of the body, to delimit the moulding space (in particular to delimit the lateral surface of lateral space of the moulding space that is configured to form the side wall of the cap). The longitudinal surface of the body can be configured to define the external surface of the side wall of the cap, while the drawer is configured to determine recess or narrow thickness zone on the side wall of the cap.

Preferably, the longitudinal surface of the body is stationary along the radial direction (with respect to the drawer, which moves along the radial direction).

In an example, the body of the lower half mould comprises a drawer seat, configured to house the drawer. In particular, the drawer seat is provided on the longitudinal surface of the body. The drawer is configured to move inside the drawer seat of the longitudinal surface of the body, in the movement between the retracted position and the closed position.

Preferably, the drawer and the driving structure are associated with the same half mould between the lower half mould and the upper half mould, more preferably, they are associated with the lower half mould.

In an embodiment, the drawer, the cam and the wheel are associated with the same half mould between the lower half mould and the upper half mould.

Preferably, when the drawer, the cam and the wheel are associated with the lower half mould (or the upper half mould), the drawer is configured to move along the radial direction only when the upper half mould (or the lower half mould) has completed its movement along the longitudinal direction towards the closed configuration of the mould. For example, the drawer is configured to move along the radial direction when an extractor and a core have completed their reciprocal movement towards the closed configuration of the mould; this prevents the drawer and the upper half mould, specifically the drawer and he core of the upper half mould, from scraping against each other.

In an example, the drawer is associated with the body of the lower half mould. The driving structure may be fixed to the plunger (that is to say, the driving structure may be movable as one with the plunger). In an example, the upper half mould comprises a core and an extractor. Preferably, the extractor is movable relative to the core between an advanced position and a retracted position. The drawer may be associated with the extractor of the upper half mould. The driving structure may be associated with (that is, movable as one with) the core of the upper half mould.

Preferably, when the drawer is at the closed position, the plunger is at a position between the retracted position and the advanced position. Thus, the compression of the dose is not completed until after the drawer has reached the closed position. In another example, when the drawer is at the closed position, the extractor is at a position between the advanced position and a retracted position.

In an embodiment, the mould comprises a plurality of spacers. Each spacer may be connectable to the plunger and interchangeable with the other spacers to vary a longitudinal distance between the driving structure and the plunger when the mould is at the open position. In another example, each spacer is connectable to the plunger and interchangeable with the other spacers to vary a longitudinal distance between the driving structure (preferably associated with the core of the upper half mould) and the core when the mould is at the open position.

In an example, the plunger comprises a transverse surface, communicating with the recess. The transverse surface contributes to delimiting the moulding space when the plunger is at the advanced position. In this case, each spacer is interchangeable with the other spacers to vary a longitudinal distance between the driving structure and the transverse surface of the plunger when the mould is at the open position (or the plunger at the advanced position), or to vary a height of the transverse surface of the plunger along the longitudinal axis. Thus, the movement of the plunger between the retracted position and the advanced position is kinematically linked to the movement of the drawer in the radial direction. The spacers can be used to decide the moment the drawer reaches the closed position relative to the moment the plunger reaches the advanced position, hence the dose is compressed in the moulding space.

In an embodiment, the wheel is associated with the driving structure and the drawer comprises a rear surface defining the cam of the movement system. In another example, the driving structure defines the cam of the movement system and the wheel is associated with the drawer.

In an example embodiment, the movement system is configured to keep the wheel engaged on the cam the whole time the mould is moving between the open position and the closed position. In this case, the wheel and the cam are preferably associated with the same half mould between the upper half mould and the lower half mould. That way, during the movement from the open position to the closed position, the wheel runs smoothly on the cam.

In an example, the upper half mould comprises a core and an extractor. The core and the extractor may be reciprocally movable along the longitudinal axis. Preferably, the extractor is movable relative to the core between an advanced position and a retracted position. The upper half mould may comprise an upper elastic assembly. The upper elastic assembly may be configured to connect the extractor to the core. Preferably, the elastic assembly is configured to be compressed when the extractor is at the retracted position.

In an embodiment, the lower half mould comprises a lower elastic assembly, configured to connect the body to the plunger. Preferably, the lower elastic assembly is configured to be compressed when the plunger is at the advanced position.

The upper elastic assembly and/or the lower elastic assembly may comprise a plurality of elastic assemblies. Preferably, the lower elastic assembly is more rigid than the upper elastic assembly. In this case, during the movement of the mould from the open position to the closed position, the compression of the upper elastic assembly occurs first, followed by the compression of the lower elastic assembly, so that the movement of the plunger to the advanced position is the last movement.

In an embodiment, the mould comprises a plurality of drawers, each interchangeable with the other drawers in order to vary the head surface.

In an example, the mould comprises a guide, configured to guide the drawer as it runs in the radial direction, and an elastic element, configured to keep the drawer at the retracted position when no other forces are applied to the drawer.

In an example embodiment, the retracted position and the closed position of the drawer define a start-of-stroke and an end-of-stroke position along the radial direction, respectively. The start-of-stroke and/or the end-of-stroke position may be variable along the radial direction to vary a distance between the head surface of the drawer, at the closed position, and the moulding space.

In an embodiment, the mould comprises a ducting system, configured to allow a cooling fluid to flow, for example in (inside) the upper half mould, and/or in (inside) the lower half mould. The ducting system comprises one or more ducts configured to allow a colling fluid to flow. In particular, the ducting system is configured for providing a circulation of fluid, whereby a flow of refrigerating liquid flows through the plurality of ducts according to a predetermined flow path.

In an example, the ducting system is provided in the lower half mould. In particular, the ducting system can extend inside the body of the lower half mould, for example through a body duct (or first duct). Additionally, or alternatively, the ducting system can extend inside the plunger of the lower half mould, for example through a plunger duct (or second duct). The ducting system can be configured to put into fluid communication a duct provided in the body (that is the body duct or first duct) with a duct provided in the plunger (that is the plunger duct or second duct). In another example, a duct provided in the plunger and a duct provided in the body are independent with each other.

The ducting system can extend outside the upper half mould, for example through an external duct or through a plurality of (external) ducts. The external duct or the plurality of ducts can be configured to put into fluid communication the duct provided in the plunger with the duct provided in the body.

For example, the ducting system can comprise a first duct, provided in the body of the lower half mould, so allow a cooling fluid to flow inside the body. The body can comprise a longitudinal portion defining a longitudinal surface contributing to form the (external surface of the) side wall of the cap. The first duct can extend inside the body in correspondence of the longitudinal portion, so to allow a refrigerating liquid to circulate around the moulding space. In particular, the first duct surrounds (a longitudinal extending portion of) the moulding space. Hence, the refrigerating liquid circulates inside the first duct around (a longitudinal extending portion of) the moulding space.

For example, the ducting system can comprise a second duct, provided in the plunger of the lower half mould, so allow a cooling fluid to flow inside the plunger. The plunger can comprise a longitudinal extending portion defining a transversal surface contributing to delimiting the moulding space (contributing to form the transverse wall of the cap). The second duct can extend inside the plunger in correspondence of the longitudinal extending portion, so to allow a refrigerating liquid to circulate inside the longitudinal extending portion of the body.

The second duct can extend inside the base of the lower half mould, so to allow a cooling fluid to flow inside the base of the lower half mould.

The plurality of (external) ducts can be configured to connect the first duct with the second duct (and viceversa).

In particular, the first duct can have a delivery duct and a return duct. The fluid can circulate towards the moulding space in the delivery duct of the first duct. The fluid can circulate away from the moulding space in the return duct of the first duct. In particular, the fluid can circulate inside the delivery duct with a delivery sense and inside the returning duct with a returning sense that is opposite to the delivery sense. In other words, the first duct can have a delivery duct for circulating the fluid towards the moulding space, and can have a return duct for circulating the fluid returning from the moulding space.

The second duct can have a delivery duct and a return duct. The fluid can circulate towards the moulding space in the delivery duct. The fluid can circulate away from the moulding space in the return duct.

In an embodiment, the plunger includes an internal portion (or stem). Preferably, the internal portion extends longitudinally. The plunger can include an external portion, configured to partially surround to internal portion. The external portion of the plunger can extend cylindrically around the longitudinal axis (that is, around the internal portion of the plunger), for example, in a longitudinally extending portion. The external portion of the plunger can extend transversely to the longitudinal axis, for example in a transversely extending portion. In an example, the transversely extending portion defines at least partially the transverse surface of the plunger. The external portion of the plunger partially surrounds the internal portion of the plunger so to form a slot between the external portion and the internal portion.

For example, the second duct (in particular, the delivery duct of the second duct) can be (partially) located inside the internal portion of the plunger. In other words, the second duct (the delivery duct of the second duct) can extend at least partially inside the internal portion of the plunger. The second duct (in particular, the delivery duct of the second duct) can be (partially) located inside the slot between the external portion and the internal portion of the plunger, for example in correspondence of the transversely extending portion of the external portion. The second duct (in particular, the delivery duct of the second duct) can be (partially) located inside the slot between the external portion and the internal portion of the plunger, for example in correspondence of the longitudinally extending portion of the external portion. In other words, the second duct (the delivery duct of the second duct) can extend at least partially inside the slot between the external portion and the internal portion of the plunger, for example in correspondence of the transversely extending portion and the longitudinally extending portion of the external portion. The second duct (in particular, the delivery duct of the second duct) can be (partially) located in the base. Preferably, the second duct (in particular, the delivery duct of the second duct) extends inside the internal portion of the plunger, through the slot between the internal and external portion in correspondence of the transversely and the longitudinally extending portion and the base.

In an embodiment, the second duct (in particular, the return duct of the second duct) can be (partially) located inside the base.

In an example, the plurality of (external) ducts comprises a delivery duct, configured to connect the delivery duct of the first duct with the delivery duct of the second duct. In an example, the plurality of (external) ducts comprises a return duct, configured to connect the return duct of the first duct with the return duct of the second duct. Therefore, the refrigerating fluid is configured to pass through the delivery duct of the second duct, the delivery duct of the external duct and the delivery duct of the first duct; the refrigerating fluid is configured to pass through the return duct of the first duct, the return duct of the external duct and the return duct of the second duct.

The ducting system can have an input end, configured to feed the ducting system with the refrigerating fluid (that is the fluid that is to be circulating in the lower half mould). The ducting system can have an output end, configured to exit the refrigerating liquid (that is the fluid that has circulated in the lower half mould). In an example, the input end and/or the output end are provided in the lower half mould, in particular in the base of the lower half mould. The input end of the ducting system can be connected to the delivery duct of the second duct. In other words, the second duct (in particular, the delivery duct of the second duct) can be configured to receive the refrigerating fluid from the input end. The output end of the ducting system can be connected to the return duct of the second duct. In other words, the output end can be configured to receive the refrigerating fluid from the second duct (in particular, from the return duct of the second duct).

The plurality of external ducts (that is the delivery duct and the return duct of the plurality of external ducts) is configured to allow the reciprocal movement along the longitudinal axis between the plunger and the body. For example, the external ducts can comprise a deformable material.

The present description also provides a mould for making a cap, wherein the mould can comprise a ducting system. The mould comprises a lower half mould. The lower half mould can include a body and a plunger. The plunger can be movable relative to the body (or vice versa) between a retracted position, where it acts in conjunction with the body to form a recess for receiving the dose, and an advanced position, where it at least partly occupies the recess. In an example, the body and the plunger are fixed with respect to each other. The mould comprises an upper half mould, where the lower half mould and the upper half mould are reciprocally movable along a longitudinal axis between an open position of the mould and a closed position of the mould, where they delimit the moulding space, the recess being open onto the moulding space. The mould comprises a ducting system. The ducting system can be made according to one or more characteristics of the present description. The ducting system can be configured to allow a cooling fluid to flow, preferably in the lower half mould. In particular, the ducting system is provided in the lower half mould. In an example, the ducting system extends inside the body and inside the plunger of the lower half mould, preferably through a duct that puts a duct provided inside the plunger and a duct provided inside the body into fluid communication.

This invention also provides a compression moulding machine for making caps, where the machine comprises a plurality of moulds according to one or more aspects of this disclosure. In an example, the moulding machine is a rotary machine, that is to say, a machine comprising a carousel configured to rotate an axis of rotation, where the axis of rotation is preferably parallel to the longitudinal axis. The carousel may include a plurality of moulds according to one or more aspects of this disclosure. Preferably, the moulds of the plurality of moulds are mounted on the carousel, angularly spaced about the axis of rotation.

This disclosure also provides a method for making a cap for a container by compressing a dose of material in a moulding space.

The method comprises a step of providing a lower half mould. The lower half mould may be made according to one or more aspects of this disclosure. Preferably, the lower half mould includes a body and a plunger, where the plunger is movable relative to the body between a retracted position, where it acts in conjunction with the body to form a recess configured to receive the dose, and an advanced position, where it at least partly occupies the recess. The method comprises a step of providing an upper half mould. The upper half mould may be made according to one or more aspects of this disclosure. Preferably, the lower half mould and the upper half mould are reciprocally movable along a longitudinal axis between an open position of the mould and a closed position of the mould, where they delimit the moulding space and the recess is open onto the moulding space.

In an example, the plunger moves with respect to the body or, more preferably, the body moves with respect to the plunger so that the plunger, relative to the body, moves between a retracted position and an advanced position.

The method can comprise a step of providing a base in the lower half mould, that is preferably fixed along the longitudinal axis, wherein the plunger can is fixed to the base, while the body can be movable along the longitudinal direction. The method comprises a step of providing a drawer, made according to one or more aspects of this disclosure. Preferably, the drawer is movable along a radial direction relative to the longitudinal axis, between a retracted position, distal to the moulding space, and a closed position, proximal to the moulding space, and including a head surface which, at the closed position of the drawer, contributes to delimiting the moulding space.

The method comprises a step of closing the mould by moving the upper half mould and the lower half mould close to each other along the longitudinal axis. The method comprises a step of moving the drawer from the retracted position to the closed position by means of a movement system, preferably driven by the movement of the upper half mould and the lower half mould towards each other. The method may include a step of synchronizing the movement of the drawer between the retracted position and the closed position and the movement of the upper half mould and the lower half mould towards each other.

In an embodiment, the movement system includes a driving structure, movable longitudinally. Alternatively, the driving structure is fixed longitudinally. In an example, the movement system includes a cam and a wheel, that is to say, the method includes a step of providing a longitudinally movable driving structure and, preferably, a cam and a wheel. Alternatively, the method may comprise a step of providing a contoured surface and a complementary contoured surface, configured to interact with each other.

In an example, the method comprises a step of moving the driving structure along the longitudinal axis. In an example, the method includes a step of the wheel and the cam interacting to produce the movement of the drawer, preferably responsive to the longitudinal movement of the driving structure. The cam may be attached to the drawer and the wheel connected to the driving structure, or vice versa. In the case where there is a contoured surface and a complementary contoured surface, the contoured surface may be attached to the drawer and the complementary contoured surface may be attached to the driving structure, or vice versa.

In an example, the drawer, the cam and the wheel are associated with the same half mould between the lower half mould and the upper half mould. When the driving structure is provided in the lower half mould, the driving structure can be fixed (directly or indirectly) to the plunger, so that the body moves along the longitudinal direction with respect to the driving structure and to the plunger.

In an example, the method comprises a step of providing the plunger fixed, through a first locking key, to the base, so to lock the angular position of the plunger around the longitudinal axis with respect to the base. The method can comprise a step of providing the body fixed, through a second locking key, to the plunger, so to lock the angular position of the body with respect to the plunger. The second locking key angularly locks the body to the plunger, while allowing the body to move along the longitudinal axis.

In an example, the method comprises a step of providing a hollow cylinder in the lower half mould. When the driving structure is in (associated with) the lower half mould, the hollow cylinder can define the driving structure. The hollow cylinder develops cylindrically around the longitudinal axis. The hollow cylinder can be placed externally (surround) the plunger and the body. In an example, the lower half mould comprises a base. The base can be fixed along the longitudinal axis. The plunger can be fixed to the base. Preferably, the hollow cylinder is fixed to the plunger so that the hollow cylinder, together with the plunger (and the base), and the body translate reciprocally along the longitudinal axis. In particular, the hollow cylinder is fixed to the plunger and the body moves along the longitudinal axis while the hollow cylinder, together with the plunger (and the base), is fixed along the longitudinal axis.

In an example, the method comprises a step of providing a ring in the lower half mould. The ring develops annularly around the longitudinal axis. The hollow cylinder can develop longitudinally from a lower to an upper extreme. Preferably, the ring is fixed to the upper extreme of the hollow cylinder, for example through one or more locking screw. The step of providing a ring includes coupling one or more eyeholes provided in the ring to one or more corresponding holes provided in the upper extreme of the hollow cylinder, through one or more corresponding locking screw. Preferably, the one or more eyeholes of the ring extend angularly around the longitudinal axis, so that the ring and the hollow cylinder can be fixed together with a predetermined angular position.

In an example, the method comprises a step of providing a wheel holder in the lower half mould. The wheel can run (or roll) on the cam, so to move the drawer in a radial direction, consequently to the relative movement between the upper and the lower half mould. The wheel holder supports the wheel. The wheel is (jointly) connected to the wheel holder.

In particular, the wheel holder is connected to the ring. The ring includes a wheel holder seat, to house the wheel holder. In particular, the wheel holder has one or more eyeholes, to engage with one or more holes of the ring through a one or more corresponding fixing screw, so to fix the wheel holder to the ring (more in particular, to the seat of the ring). Preferably, the one or more eyeholes of the wheel holder develop in one or more corresponding radial directions. Hence, it is possible to fix the wheel holder in a predetermined distance along the radial direction, so to change the distance of the wheel from the drawer.

In an example, the ring and the hollow cylinder constitutes separate components, in another example, the ring is integrated in the hollow cylinder. Hence, the wheel holder can be fixed to the hollow cylinder (in case the ring is integrated to the hollow cylinder), or to the ring (in case the ring and the hollow cylinder constitutes separate components). Hence, the seat for the wheel holder can be provided in the hollow cylinder.

The wheel holder is angularly fixed to the ring (or to the hollow cylinder) so to align the wheel to the cam, so that the wheel runs or roll on the cam to move the drawer in the radial direction.

In an example, the drawer is associated to the body of the lower half mould and the cam is provided on a rear surface of the drawer (in other words, the drawer comprises a rear surface that defines the cam of the movement system). Preferably, during the relative movement of the body and the plunger along the longitudinal direction, the wheel rolls on the rear surface of the drawer so that the wheel and the drawer move relative in the radial direction (in particular, the drawer moves in the radial direction). In particular, the body moves along the longitudinal direction with respect to the plunger and the wheel (connected to the wheel holder that is connected to the hollow cylinder directly or indirecly) pushes the drawer towards the closed position.

In an example, the drawer comprises a head surface, opposite to the rear surface. Preferably, the head surface develops symmetrically with respect to an axis that is parallel to the longitudinal axis. The head surface may develop in symmetrical shape, in particular in a semi-circular shape around the longitudinal axis. Preferably, the drawer, that is the head surface, presents a width along a direction perpendicular to the longitudinal axis that is smaller than a diameter of the cap. In the movement between the retracted position and the closed position, the drawer moves along the radial direction so that each point of the head surface moves along a direction that intersects the longitudinal axis (i.e. each point of the head surface moves along a radial direction). In particular, during the movement between the retracted position and the closed position, the centre of mass (or centre of gravity) of the drawer moves along an axis (that is the radial direction) that intersects the longitudinal axis; in other words, the centre of mass (or centre of gravity) of the drawer moves along the radial direction.

The lower half mould defines a lateral portion of the moulding space that forms the (external surface of the) side wall of the cap. The drawer can contribute, along with the lower half mould, to delimit the moulding space (in particular, to delimit the lateral portion of the moulding space that forms the side wall of the cap). The lower half mould defines the external surface of the side wall of the cap, while the drawer forms a recess or narrow thickness zone on the side wall of the cap.

Preferably, the portion of the lower half mould that forms the external surface of the side wall of the cap is stationary along the radial direction (with respect to the drawer which moves along the radial direction).

In an example, the body of the lower half mould comprises a longitudinal surface. The longitudinal surface contributes to delimiting the moulding space. In particular, the longitudinal surface contributes to delimiting a lateral surface or lateral space (or longitudinal surface or longitudinal space) of the moulding space. In particular, the longitudinal surface contributes to forming the (external surface of the) side wall of the cap.

The drawer (in particular, the head surface of the drawer) can contribute, along with longitudinal surface of the body, to delimit the moulding space (in particular, to delimit the lateral surface of lateral space of the moulding space that forms the side wall of the cap). The longitudinal surface of the body can define the external surface of the side wall of the cap, while the drawer forms a recess or narrow thickness zone on the side wall of the cap.

Preferably, the longitudinal surface of the body is stationary along the radial direction (with respect to the drawer, which moves along the radial direction).

In an example, the method comprises a step of providing the body of the lower half mould with a drawer seat; in particular, the drawer seat is provided on the longitudinal surface of the body. The drawer moves inside the drawer seat of the longitudinal surface of the body, during the movement between the retracted position and the closed position.

Preferably, the wheel engages the cam the whole time the mould is moving between the open position and the closed position.

Preferably, the upper half mould includes a core and an extractor connected to the core by an upper elastic assembly and movable relative to the core between an advanced position and a retracted position. The method comprises a step of moving the core and the extractor relative to each other. The method may comprise a step of compressing the upper elastic assembly, for example following the relative movement between the core and the extractor.

In an example, in the lower half mould, the body is connected to the plunger by a lower elastic assembly.

In an embodiment, the movement of the upper half mould and the lower half mould towards each other causes the core and the extractor of the upper half mould to move relative to each other. In an embodiment, the movement between the upper half mould and the lower half mould causes the body and the plunger of the lower half mould to move relative to each other.

In an example, the drawer is slidably coupled to the extractor and the driving structure is connected to the core. In this case, for example, the movement of the upper half mould and the lower half mould towards each other causes the core and the extractor to move relative to each other to cause a relative movement between the driving structure and the drawer causing the latter to move to the closed position along the radial direction.

In an example, the drawer is slidably coupled to the body and the driving structure is connected to the plunger. In this case, for example, the movement of the upper half mould and the lower half mould towards each other causes the body and the plunger to move relative to each other to cause a relative movement between the driving structure and the drawer causing the latter to move to the closed position along the radial direction.

In an embodiment, the relative movement between the extractor and the core of the upper half mould is completed before the relative movement between the body and the plunger of the lower half mould is completed. Preferably, the relative movement between the extractor and the core of the upper half mould is completed before the relative movement between the body and the plunger of the lower half mould starts.

In an embodiment, the advancing movement of the drawer to the closed position is completed before the relative movement between the body and the plunger of the lower half mould is completed.

First, therefore, the upper elastic assembly is compressed, following the relative movement between the extractor and the core, and then the lower elastic assembly is compressed, following the relative movement between the body and the plunger. In an example, the lower elastic element is more rigid than the upper elastic element, so the relative movement between the core and the extractor occurs before the relative movement between the body and the plunger is completed (or starts).

In an embodiment, the method comprises a step of replacing spacers of a plurality of spacers, where each spacer is connectable to the plunger and is interchangeable with the other spacers in order to vary a longitudinal distance between the driving structure and the plunger when the mould is at the open position. The method may comprise a step of connecting the spacers to the plunger, so that the advancing movement of the drawer, which is associated with the body, to the closed position is completed before the movement of the plunger, which the driving structure is associated with, to the advanced position is completed.

Alternatively, the method comprises a step of replacing spacers of a plurality of spacers, where each spacer is connectable to the core and is interchangeable with the other spacers in order to vary a longitudinal distance between the driving structure and the core when the mould is at the open position. The method may comprise a step of connecting the spacers to the core, so that the advancing movement of the drawer, which is associated with the extractor, to the closed position is completed before the movement of the core, which the driving structure is associated with, to the advanced position (relative to the extractor) is completed.

In an embodiment, method comprises a step of providing a ducting system. The ducting system can be made according to one or more characteristics of the present description. Preferably, the ducting system is provided in (inside) the lower half mould. In particular, the ducting system extends inside the body and inside the plunger through a duct that puts a duct provided inside the plunger and a duct provided inside the body into fluid communication.

The method can comprise a step of providing the duct system with a first duct in the body and/or a second duct in the plunger. The method can comprise a step of putting into fluid communication a duct provided in the body (that is the first duct) with a duct provided in the plunger (that is the second duct). In another example, a duct provided in the plunger and a duct provided in the body are independent with each other. The method can comprise a step of providing the duct system with an external duct or a plurality of (external) ducts. The method can comprise a step of putting into fluid communication the duct provided in the plunger with the duct provided in the body through the external duct or the plurality of ducts.

The body can comprise a longitudinal portion defining a longitudinal surface. The longitudinal surface contributes to form the (external surface of the) side wall of the cap. The first duct can extend inside the body in correspondence of the longitudinal portion, so to allow a refrigerating liquid to circulate around the moulding space. In particular, the first duct surrounds (a longitudinal extending portion of) the moulding space. Hence, the refrigerating liquid circulates inside the first duct around (a longitudinal extending portion of) the moulding space. The method can comprise a step of refrigerating the body, in particular the longitudinal portion of the body, for example through a flow of liquid inside the first duct that surrounds the moulding space in correspondence of the longitudinal portion of the body.

In an example, the plunger comprises a longitudinal extending portion and a transversal estending portion defining a transversal surface. The transversal surface contributes to delimiting the moulding space (contributing to form the transverse wall of the cap). The second duct can extend inside the plunger in correspondence of the longitudinal extending portion and of the transversal extending portion, so to allow a refrigerating liquid to circulate inside the longitudinal extending portion and the transversal extending portion of the plunger.

The second duct can extend inside the base of the lower half mould, so to allow a cooling fluid to flow inside the base of the lower half mould.

The method can comprise a step of providing the first duct with a delivery duct and a return duct. The method can comprise a step of flowing of fluid towards the moulding space through the delivery duct of the first duct (for example in a delivery sense). The method can comprise a step of flowing of liquid away from the moulding space in the return duct of the first duct (for example in a return sense opposite to the delivery sense).

The method can comprise a step of providing the second duct with a delivery duct and a return duct. The fluid can circulate towards the moulding space in the delivery duct of the second duct. The fluid can circulate away from the moulding space in the return duct of the second duct.

In an embodiment, the method comprises a step of providing the plunger with an internal portion extending longitudinally, and an external portion, partially surrounding to internal portion. The external portion of the plunger can extend cylindrically around the longitudinal axis (that is, around the internal portion of the plunger), for example, in a longitudinally extending portion. The external portion of the plunger can extend transversely to the longitudinal axis, for example in a transversely extending portion, that defines at least partially the transverse surface of the plunger. The external portion of the plunger partially surrounds the internal portion of the plunger so to form a slot between the external portion and the internal portion.

The delivery duct of the second duct can extend at least partially inside the internal portion of the plunger. The delivery duct of the second duct can extend at least partially inside the slot between the external portion and the internal portion of the plunger, for example in correspondence of the transversely extending portion of the external portion and/or the longitudinally extending portion of the external portion. The delivery duct of the second duct can extend inside the base.

In an example, the method comprises a step of providing the plurality of (external) ducts with a delivery duct, connecting the delivery duct of the first duct with the delivery duct of the second duct. In an example, the method comprises a step of providing the plurality of (external) ducts with a return duct, connecting the return duct of the first duct with the return duct of the second duct. Hence, the method can comprise a step of flowing of refrigerating fluid through the delivery duct of the second duct, the delivery duct of the external duct and the delivery duct of the first duct; a step of flowing of refrigerating through the return duct of the first duct, the return duct of the external duct and the return duct of the second duct.

The method can comprise a step of providing the ducting system with an input end and a step of feeding the ducting system with the refrigerating fluid through the input end. The method can comprise a step of providing the ducting system with an output end a step of exiting the refrigerating liquid through the output end from the ducting system. In an example, the input end and/or the output end are provided in the lower half mould. The input end of the ducting system can be connected to the delivery duct of the second duct, so to receive the refrigerating fluid from the input end. The output end of the ducting system can be connected to the return duct of the second duct so to receive the refrigerating fluid from the returning duct of the second duct.

The plurality of external ducts (that is the delivery duct and the return duct of the plurality of external ducts) allow the reciprocal movement along the longitudinal axis between the plunger and the body. For example, the external ducts can comprise a deformable material.

The present description also provides a method for making caps for a container by compressing a dose in a moulding space, wherein the method can comprise a step of providing a ducting system. The method comprises a step of providing a lower half mould, according to one or more characteristics of the present description. Preferably the lower half can include a body and a plunger. The plunger can be movable relative to the body (or vice versa) between a retracted position, where it acts in conjunction with the body to form a recess for receiving the dose, and an advanced position, where it at least partly occupies the recess. In an example, the body and the plunger are fixed with respect to each other. The method can comprise a step of providing an upper half mould according to one or more characteristics of the present description. The lower half mould and the upper half mould are reciprocally movable along a longitudinal axis between an open position of the mould and a closed position of the mould, where they delimit the moulding space, the recess being open onto the moulding space.

The ducting system can be made according to one or more characteristics of the present description. The ducting system allows a cooling fluid to flow, preferably in the lower half mould. In particular, the ducting system is provided in the lower half mould. In an example, the ducting system extends inside the body and inside the plunger of the lower half mould, preferably through a duct that puts a duct provided inside the plunger and a duct provided inside the body into fluid communication.

### BRIEF DESCRIPTION OF DRAWINGS

These and other features will become more apparent from the following description of a preferred embodiment, illustrated by way of non-limiting example in the accompanying drawings, in which:

FIG. 1 shows a mould 1 according to one or more aspects of this disclosure;

FIG. 1A shows a cross section of a cap 2 according to one or more aspects of this disclosure;

FIGS. 2-8 show an operating sequence of a mould 1 in cross section according to one or more aspects of this disclosure;

FIGS. 9-15 show an operating sequence of a mould 1 in cross section according to one or more aspects of this disclosure;

FIGS. 16-23 show an operating sequence of a mould 1 in cross section according to one or more aspects of this disclosure;

FIGS. 24A and 24B show a mould 1 in a cross section according to one or more aspects of this disclosure;

FIG. 25 shows a schematic view of a flow path of refrigerating liquid in a mould 1 in a cross section according to one or more aspects of this disclosure;

FIGS. 26A and 27 show a mould 1 according to one or more aspects of this disclosure;

FIG. 26B shows a cross section of the mould 1 of FIG. 26A;

FIGS. 28A-28C show a wheel holder of a mould 1 in different positions according to one or more aspects of this disclosure;

FIG. 29 show an exploded of a mould 1 according to one or more aspects of this disclosure.

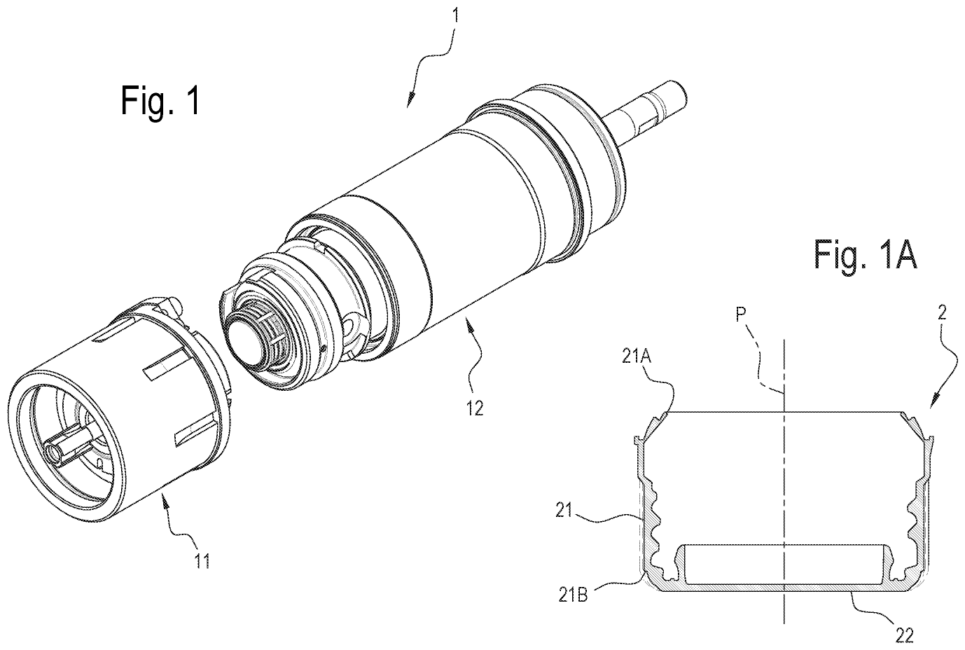

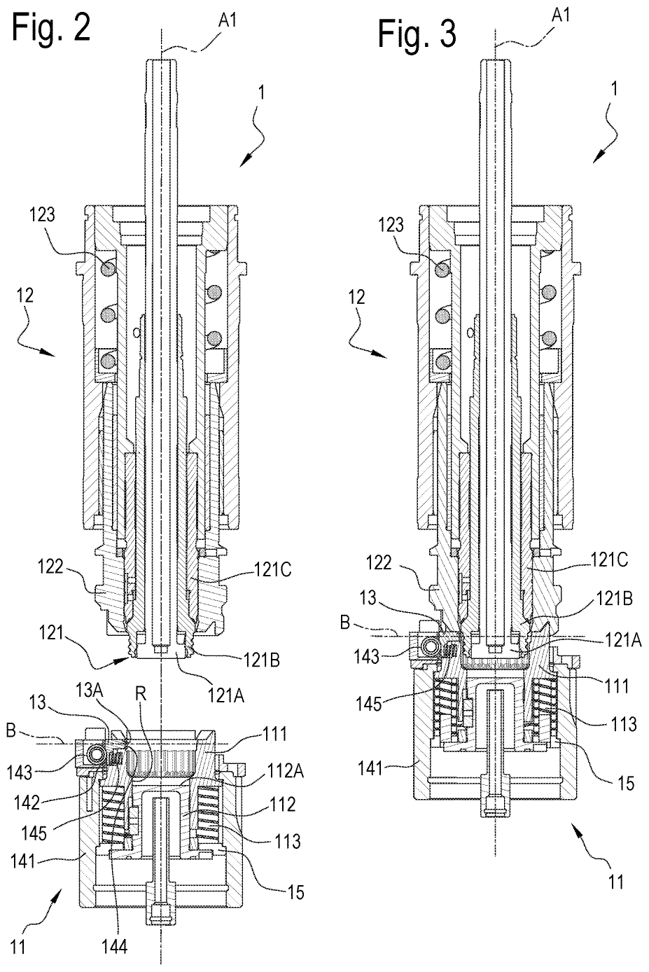

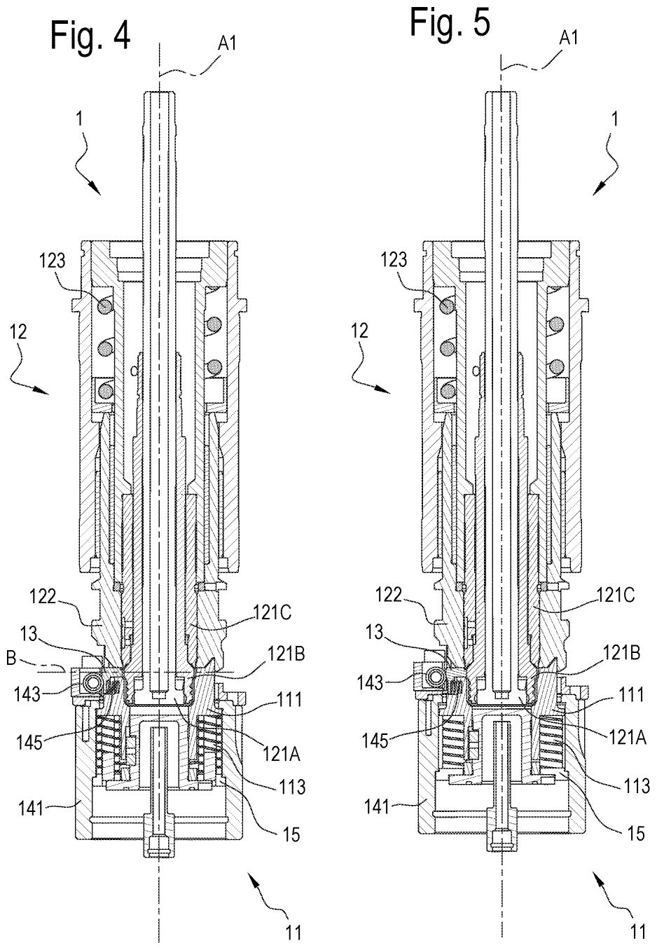

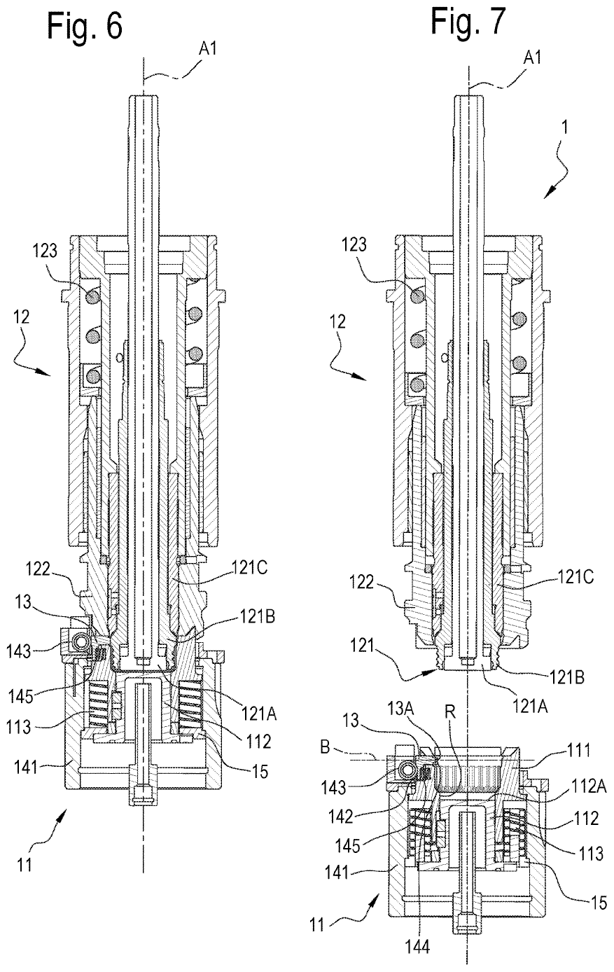

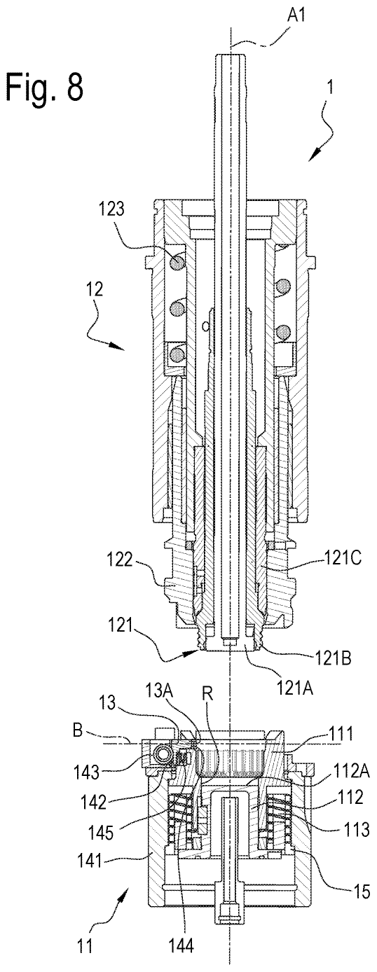

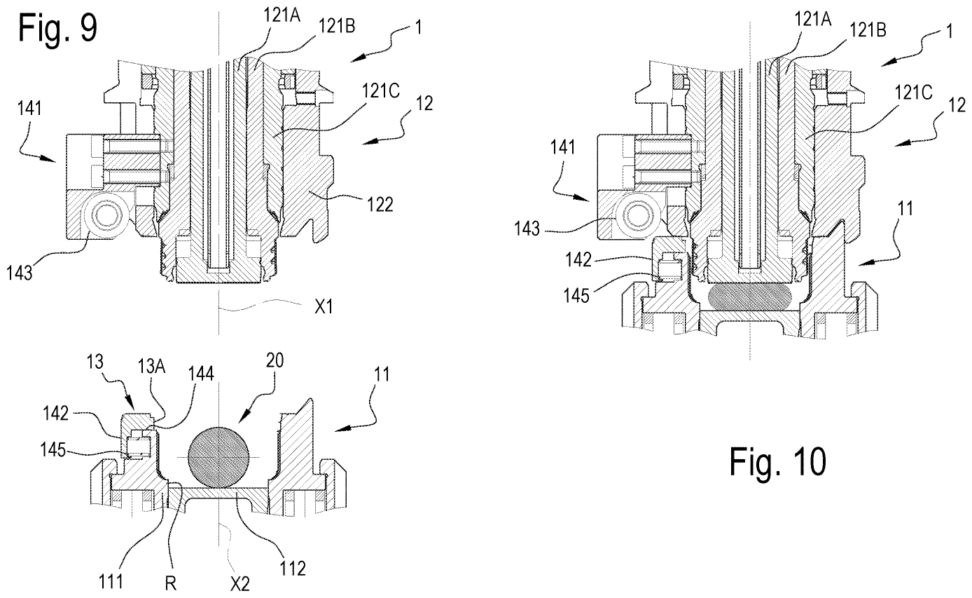

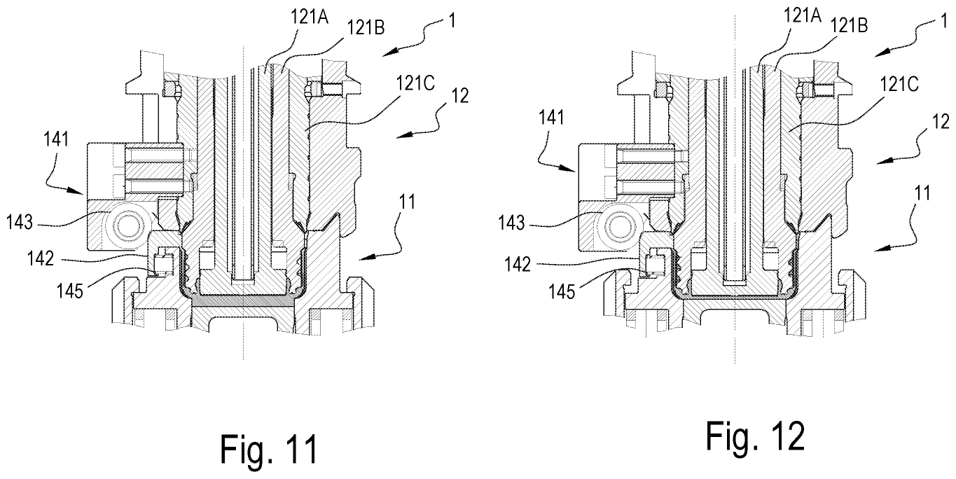

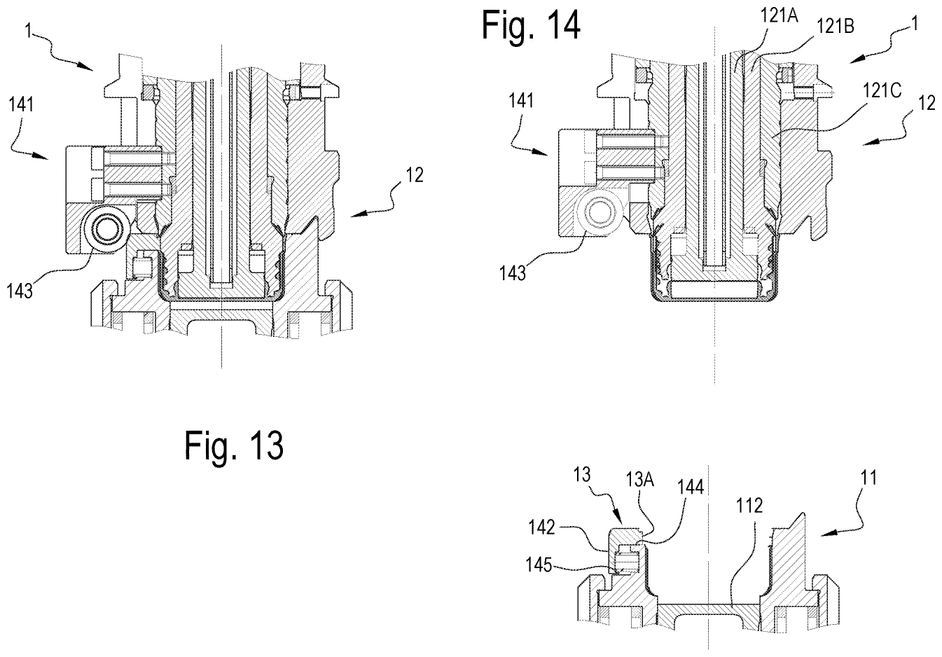

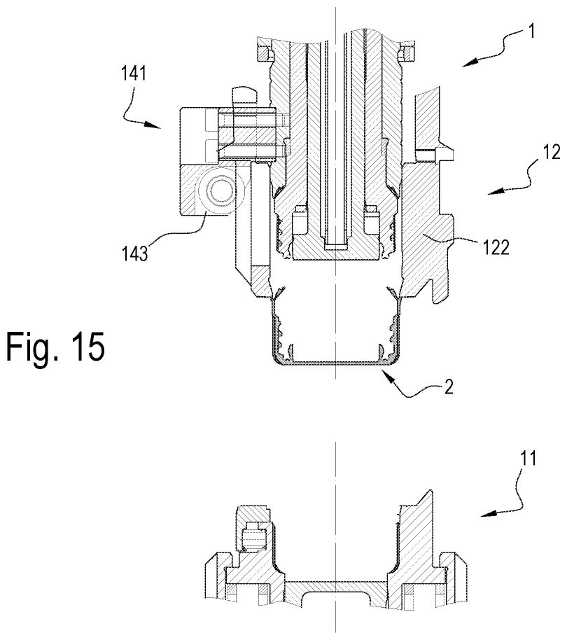

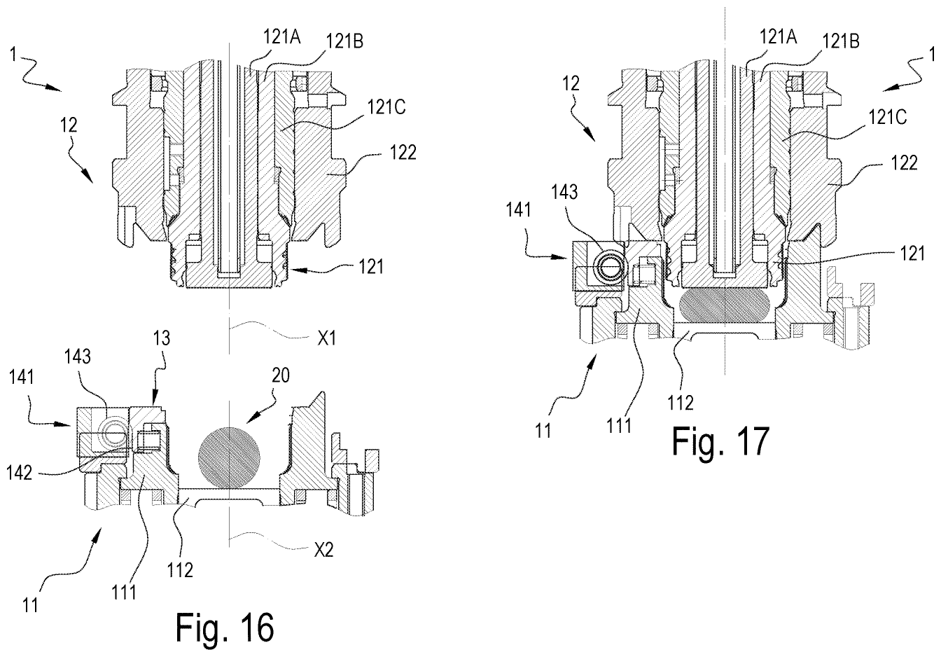

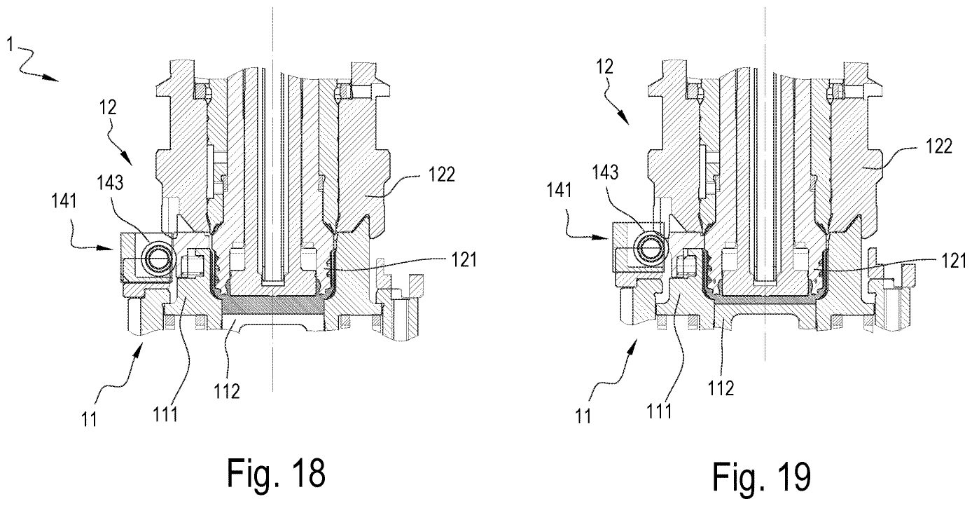

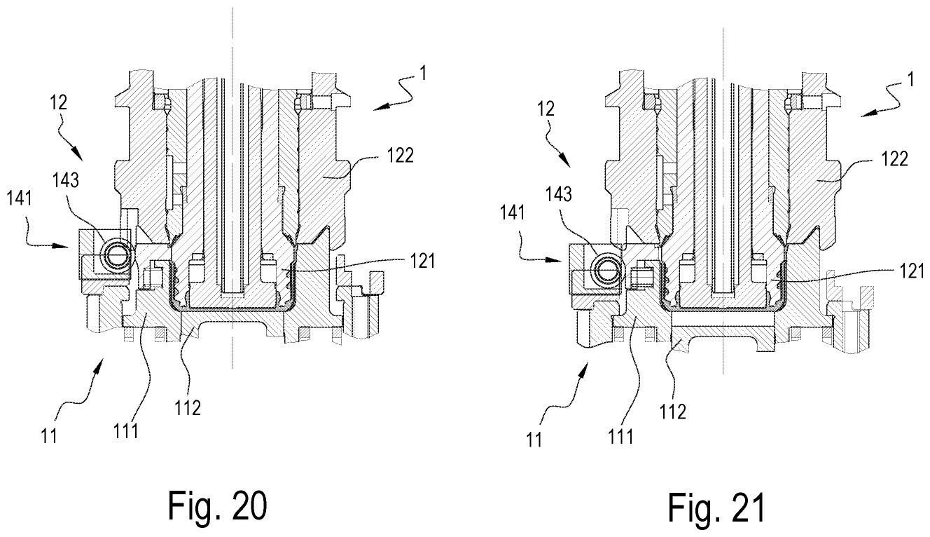

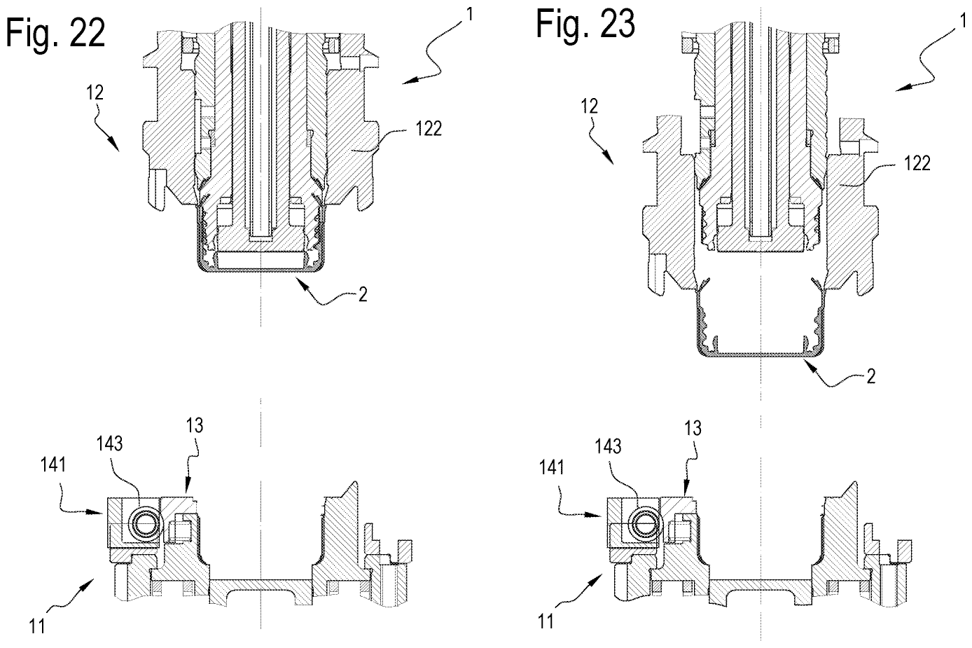

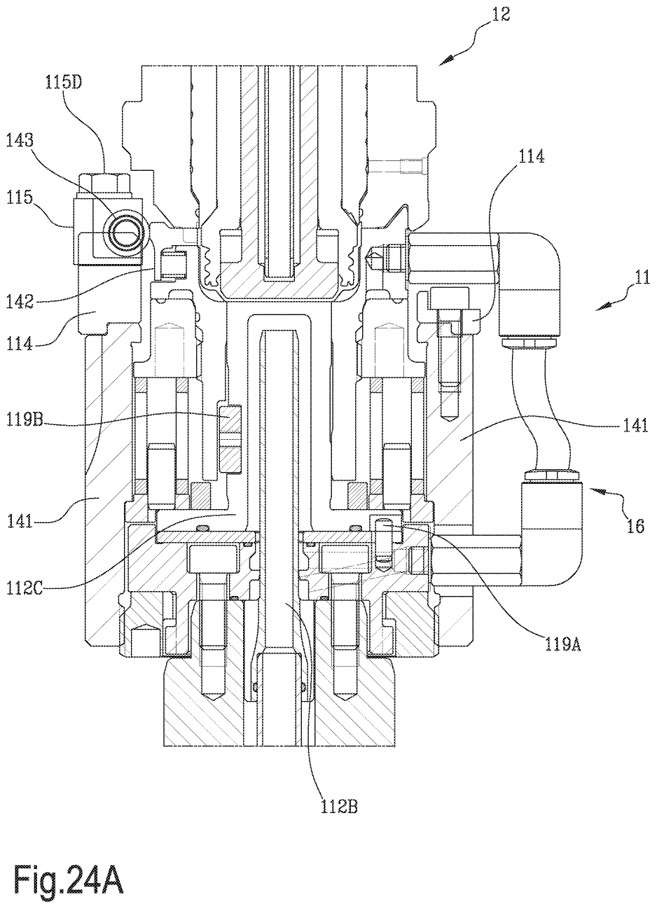

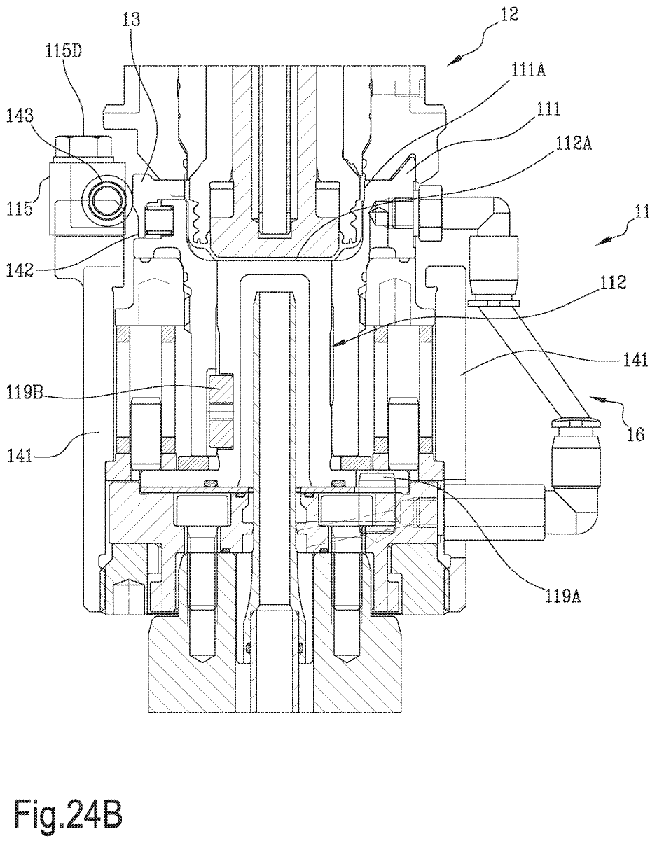

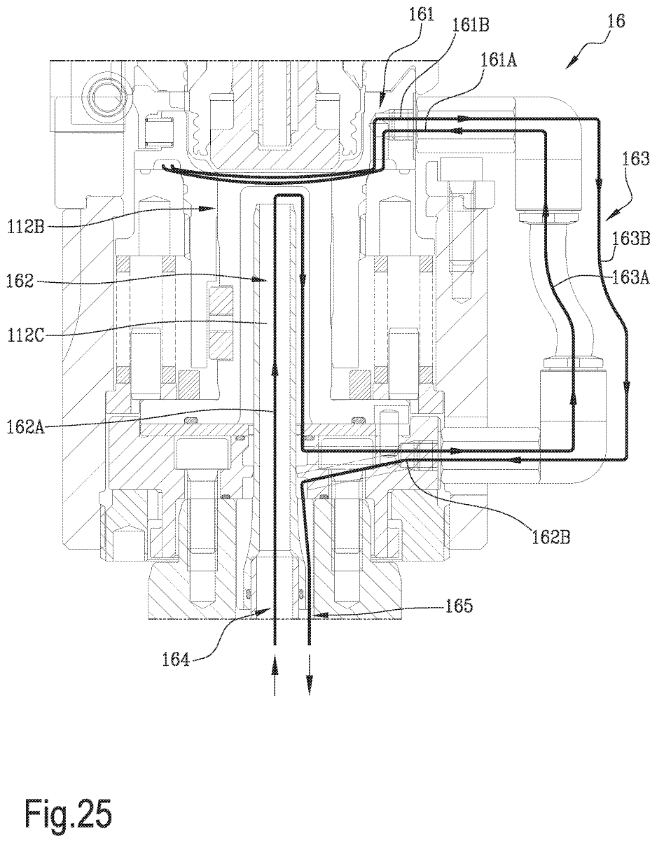

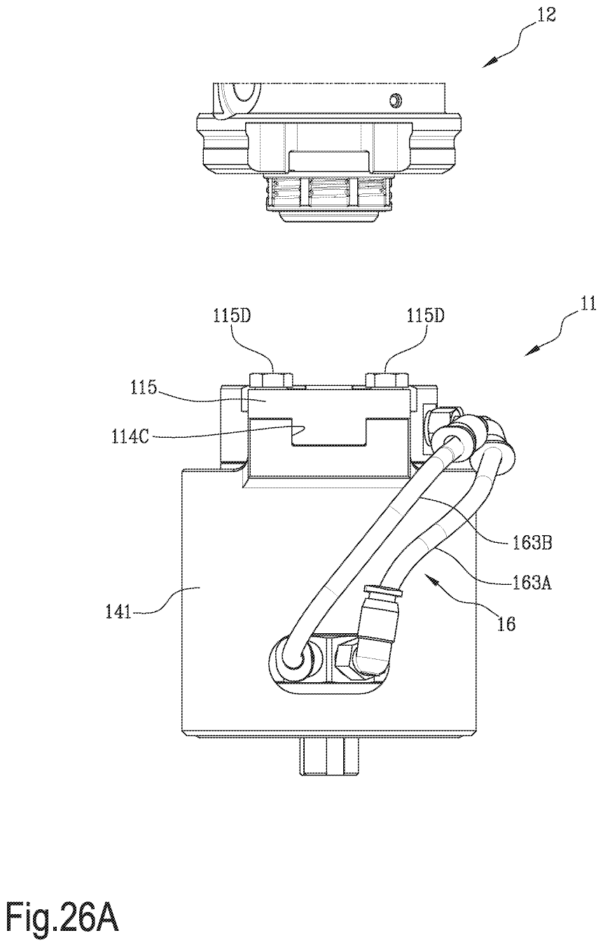

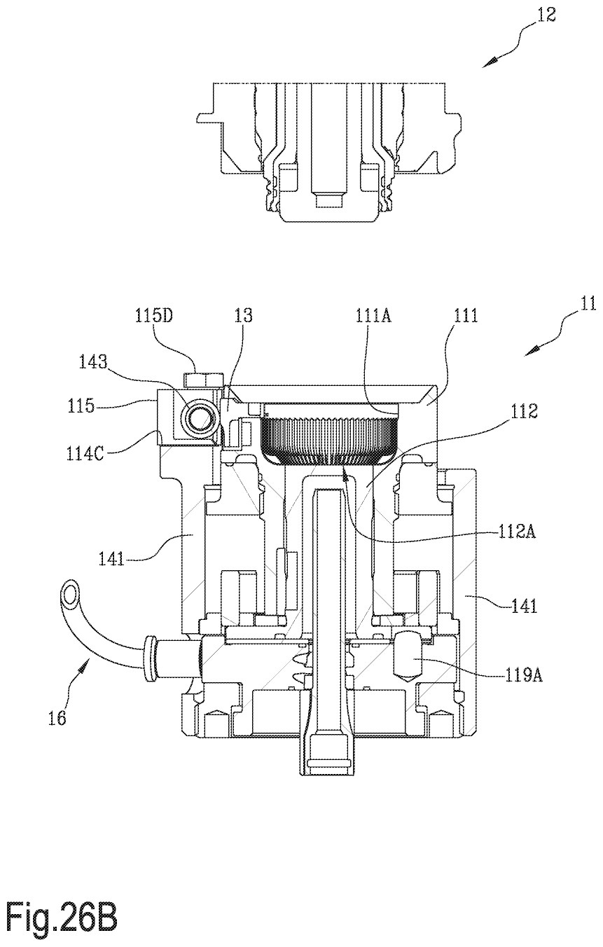

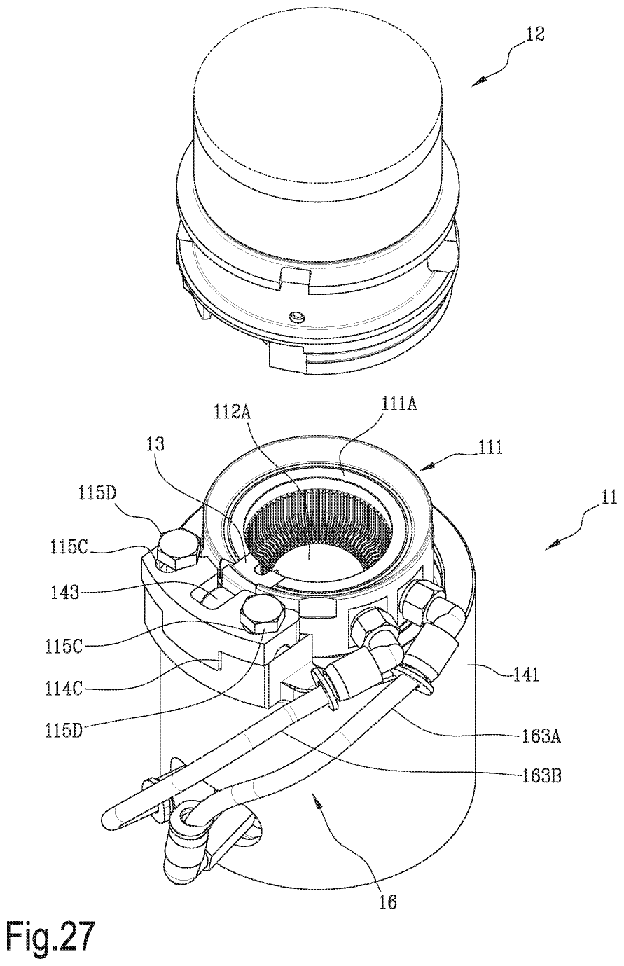

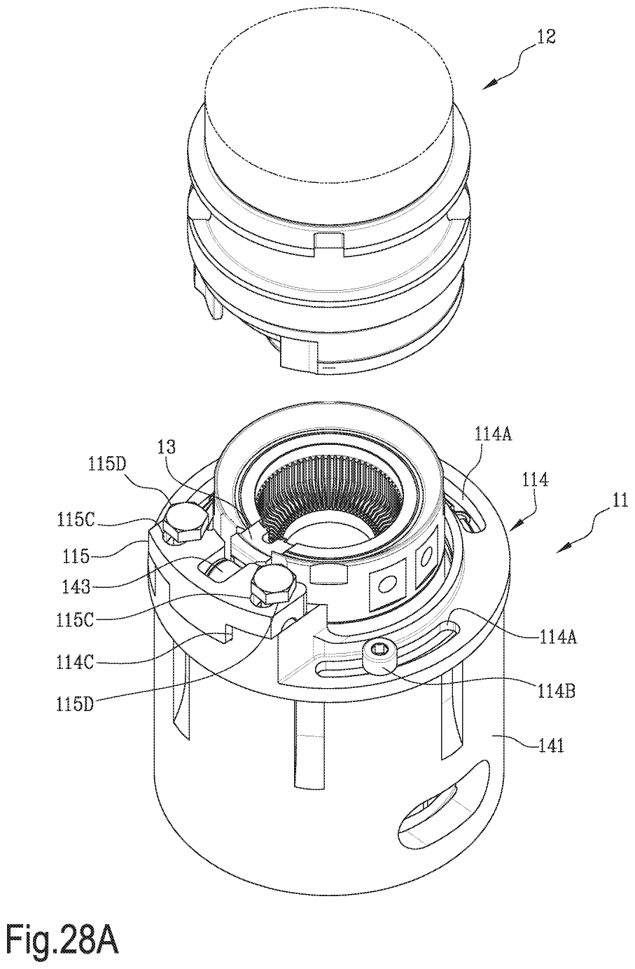

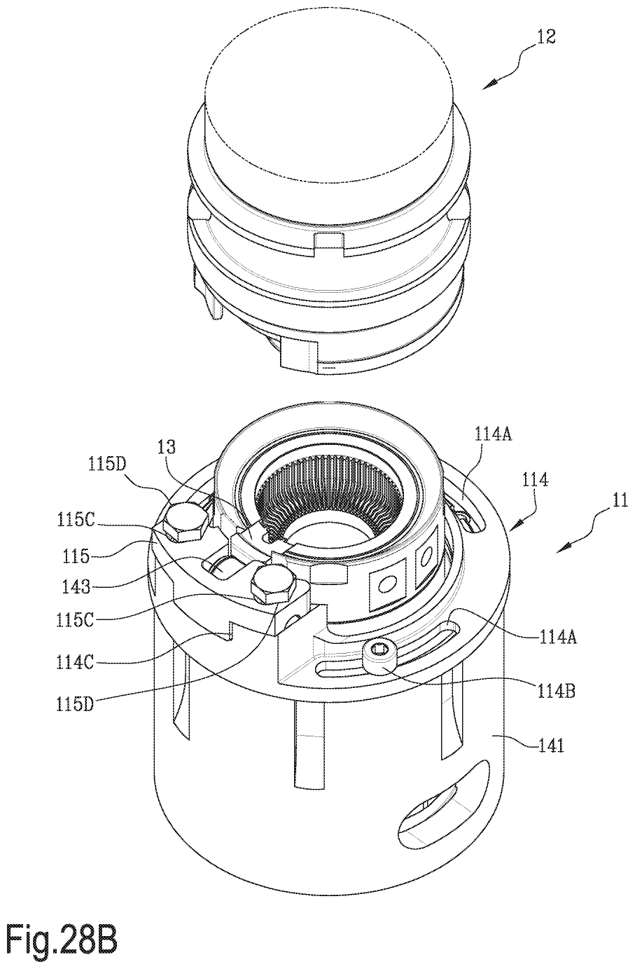

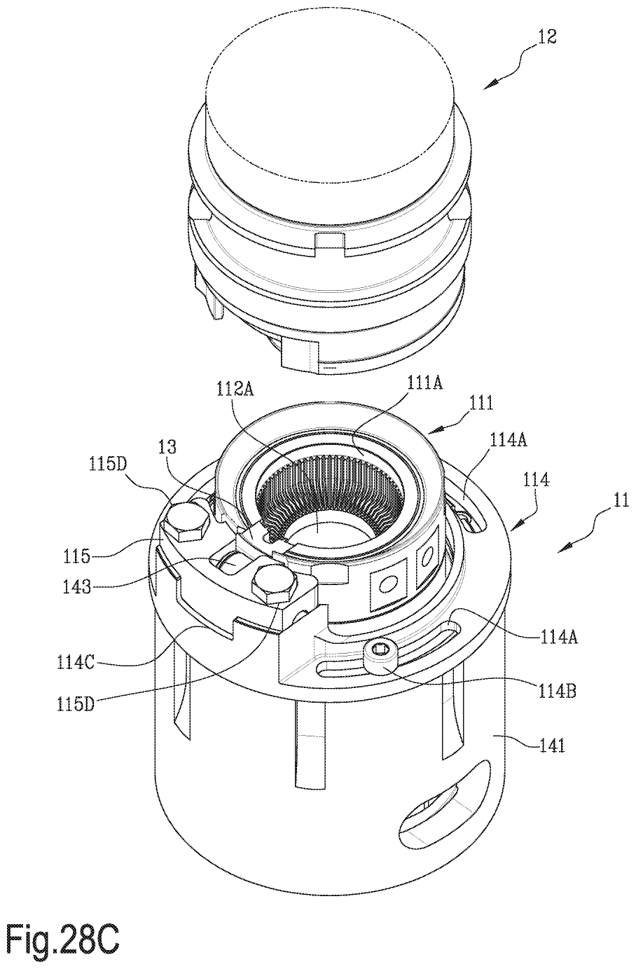

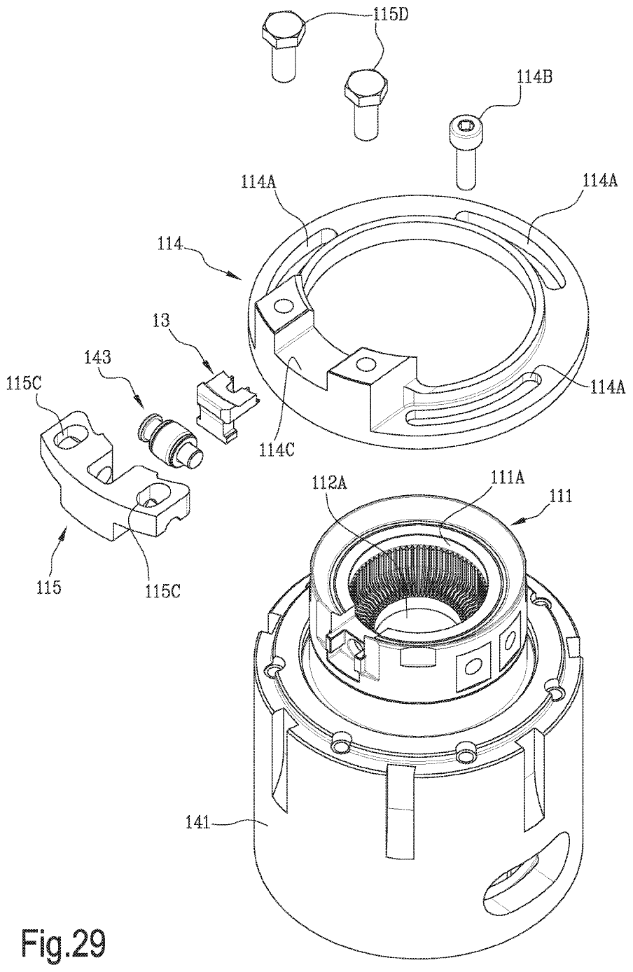

### DETAILED DESCRIPTION OF PREFERRED EMBODIMENTS OF THE INVENTION

With reference to the accompanying drawings, the numeral 1 denotes a mould for making a cap 2 for a container by compressing a dose 20 in a moulding space. More specifically, the cap 2 comprises a side wall 21, extending around a main axis P between a first end 21A and a second end 21B. The cap 2 comprises a transverse wall 22 oriented transversely to the main axis P and connected to the side wall 21 at the second end 21B of the side wall 21.

The mould 1 comprises a lower half mould 11. The lower half mould 11 defines a moulding cavity. The mould comprises an upper half mould 12. The lower half mould 11 and the upper half mould 12 are reciprocally movable along a longitudinal axis A1 between an open position of the mould 1, where the lower half mould 11 and the upper half mould 12 are spaced apart, and a closed position of the mould 1, where the lower half mould 11 and the upper half mould 12 are close together and delimit the moulding space. At the closed position of the mould 1, the upper half mould 12 is at least partly housed in the cavity of the lower half mould 11. The lower half mould 11 includes a body 111 and a plunger 112. The plunger 112 is movable relative to the body 111 between a retracted position and an advanced position. More specifically, the plunger 112 is movable along a thrust axis A2. The thrust axis A2 is preferably parallel to, or coincides with, the longitudinal axis A1.

At the retracted position, the plunger 112 acts in conjunction with the body 111 to form a recess R. The recess R is configured to receive a dose 20. At the advanced position, the plunger 112 at least partly occupies the recess R; more specifically, at the advanced position, the plunger 112 fills the recess R.

In an embodiment, the lower half mould 11 comprises a base 116, which is fixed along the longitudinal axis A1. The plunger 112 is fixed to the base 116 so that the plunger 112, together with the base 116, is fixed along the longitudinal axis A1, while the body 111 is movable along the longitudinal direction; hence, the body 111 moves relatively to the plunger 112 so that the plunger 112 moves between the retracted position and the advanced position.

The lower half mould 11 comprises a first locking key 119A, to lock the angular position around the longitudinal axis A1 of the plunger 112 with respect to the base 116. The first locking key 119A is located between the base 116 and the plunger 112. The lower half mould 11 comprises a second locking key 119B, to lock the angular position around the longitudinal axis A1 of the body 111 with respect to the plunger 112. The second locking key 119B is located between the plunger 112 and the body 111.

Preferably, the plunger 112 comprises a transverse surface 112A which contributes to delimiting the moulding space, specifically when the plunger is at the advanced position, and which is configured to at least partly form the transverse wall 22 of the cap 2.

Preferably, the body 111 comprises a longitudinal surface 111A which contributes to delimiting the moulding space and is configured to at least partly form the side wall 21 of the cap 2.

The mould comprises a drawer 13. The drawer 13 is movable between a retracted position and a closed position along a radial direction B relative to the longitudinal axis A1. At the retracted position, it is distal to the moulding space; at the closed position, it is proximal to the moulding space. More specifically, the drawer 13 comprises a head surface 13A which contributes to delimiting the moulding space. When the drawer 13 is at the closed position, close to the moulding space, the head surface 13A may be configured to be surrounded by the plastic so as to create a through hole in the side wall 21 of the cap 2, or so as to create a narrow thickness zone in the side wall 21 of the cap 2. Thus, when the drawer 13 is at the closed position, close to the moulding space, it may define a break zone where there is an interruption to the flow of plastic.

The body 111 comprises a drawer seat, provided on the longitudinal surface 111A and configured to house the drawer 13. The drawer 13 moves inside the drawer seat of the longitudinal surface 111A of the body 111, during the movement between the retracted position and the closed position of the drawer 13.

The drawer 13 may be removed and replaced with another drawer 13 having another head surface 13A, different from the head surface 13A of the previous drawer, so as to vary a shape of the hole or narrow thickness zone to be made in the side wall 21 of the cap 2.

The retracted position and the closed position of the drawer 13 define a start-of-stroke and an end-of-stroke position along the radial direction B, respectively. More specifically, the start-of-stroke position is variable along the radial direction B to vary a distance between the head surface 13A of the drawer 13, at the closed position, and the moulding space. More specifically, decreasing the distance between the head surface 13A and the moulding space makes the hole in the cap 2, while increasing the distance between the head surface 13A and the moulding space makes the reduced thickness zone or makes a traditional side wall 21 of the cap 2, that is, a wall 21 without holes or reduced thickness zones.

The mould 1 comprises a movement system configured to move the drawer 13 along the radial direction B from the retracted position to the closed position. The movement system includes a driving structure 141, movable longitudinally, a cam 142 and a wheel 143.

The mould 1 comprises a guide 144 configured to guide the drawer 13 as it runs in the radial direction, and an elastic element 145, configured to keep the drawer 13 at the retracted position when no other forces are applied to it, preferably by moving the drawer 13 along the radial direction B from the closed position to the retracted position.

Preferably, the cam 142 is attached to the drawer 13 and the wheel 143 is connected to the driving structure 141. The cam 142 and the wheel 143 are configured to interact with each other; more specifically, following the longitudinal movement of the driving structure 141, the wheel 143 runs (or rolls) on the cam 142, thereby causing the drawer to move along the radial direction B.

The upper half mould 12 comprises a core 121 and an extractor 122. The core 121 and the extractor 122 are reciprocally movable along the longitudinal axis A1. More specifically, the extractor 122 is movable between a retracted position, where the extractor 122 and the lower half mould 11 are spaced apart (and the mould 1 is at a partly open position), and an advanced position, where the extractor 112 and the lower half mould 11 are close together (and the mould 1 is at a partly closed position).

In an embodiment, the drawer 13 is associated with the lower half mould 11 and the driving structure 141 is associated with the lower half mould 11. More specifically, the drawer 13 is associated with the body 111 of the lower half mould 11 and the driving structure 141 is fixed to the plunger 112 (that is to say, it is attached to the plunger 112) so that movement of the plunger 112 in the longitudinal direction causes the driving structure 141 to move in the longitudinal direction. Thus, the driving structure 141 moves as one with the plunger 112 as it moves between the retracted position and the advanced position of the plunger 112.

In an embodiment, the drawer 13 is associated with the lower half mould 11, and the driving structure 141 is associated with the lower half mould 11; the drawer 13 is associated (connected) to the body 111 and the driving structure 141 is fixed to the plunger 112. The body 111 moves along the longitudinal direction with respect to the driving structure 141 and the plunger 112. The lower half mould 11 comprises a hollow cylinder that defines the driving structure 141. The hollow cylinder develops cylindrically around the longitudinal axis A1 and surrounds the plunger 112 and the body 111. The hollow cylinder is fixed to the plunger 112 so that the hollow cylinder is fixed along the longitudinal axis A1, while the body 111 moves along the longitudinal axis A1. The lower half mould 11 can comprise a ring 114 developing annularly around the longitudinal axis A1 and fixed to an upper extreme of the hollow cylinder. The ring 114 comprises one or more eyeholes 114A coupled to one or more corresponding holes provided in the upper extreme of the hollow cylinder, through one or more corresponding locking screw 114B. Each of the one or more eyeholes 114B of the ring 114 extend angularly around the longitudinal axis A1, so that the hollow cylinder and the ring 114 can be fixed together in a predetermined angular position with each other. The lower half mould 11 comprises a wheel holder 115 configured to support the wheel 143. The wheel 143 is jointly connected to the wheel holder 115. The ring 114 includes a wheel holder seat 114C, to house the wheel holder 115. The wheel holder 115 has one or more eyeholes 115C, configured to engage with one or more holes of the ring 114 through one or more corresponding fixing screws 115D, so to fix the wheel holder 115 to the seat 114C of the ring 114. The one or more eyeholes 115C of the wheel holder 115 develop in one or more corresponding radial direction so the radial distance of the wheel holder 115 can be changed.

The ring 114 and the hollow cylinder can constitute separate components or the ring 114 can be integrated in the hollow cylinder, so that the wheel holder 115 is directly connected to the hollow cylinder. In particular, the wheel holder 115 is angularly fixed to the ring 114 (or to the hollow cylinder) to align the wheel 143 to the cam 142, provided in the rear surface of the drawer 13. In an example (that is when the ring 114 is integrated in the hollow cylinder) the hollow cylinder comprises a wheel holder seat 114C, to house the wheel holder 115; the wheel holder 115 can have one or more eyeholes 115C, to engage with one or more corresponding holes of the hollow cylinder through one or more corresponding fixing screws 115C. The one or more eyeholes 115C of the wheel holder 115 develop in one or more corresponding radial direction so the radial distance of the wheel holder 115 can be changed.

In another embodiment, the drawer 13 is associated with the lower half mould 11 and the driving structure 141 is associated with the upper half mould. More specifically, the drawer 13 is associated with the body 111 of the lower half mould 11 and the driving structure 141 is fixed (that is, attached) to the core 121 of the upper half mould 12 so that a movement of the core 121 and the extractor 122 relative to each other in the longitudinal direction causes the driving structure 141 to move in the longitudinal direction. Preferably, the core 121 is fixed, while the extractor 122 moves between the retracted position and the advanced position.

In the example where the drawer 13 and the driving structure 141 (hence the wheel 143) are associated with the same half mould (preferably the lower half mould 11), the wheel 143 remains engaged on the cam 142 of the drawer 13 the whole time the mould is moving between the open position and the closed position.

In another example, the drawer 13 is associated with the upper half mould 12 and the driving structure 141 is associated with the upper half mould 12. More specifically, the drawer 13 may be associated with the extractor 122 and the driving structure 141 may be associated with the core 121 of the upper half mould 12 so that a relative movement between the extractor 122 and the core 121 causes a movement of the driving structure 141, hence a movement of the drawer in the radial direction B.

In yet another example, the drawer 13 is associated with the upper half mould 12 and the driving structure 141 is associated with the lower half mould. More specifically, the drawer 13 may be associated with the extractor 122 and the driving structure may be associated with the plunger 112.

The mould 1 comprises a spacer 15 connected to the plunger. More specifically, the mould 1 may comprise a plurality of spacers 15, where each spacer 15 is removably connected to the plunger 112 and is interchangeable with the other spacers 15 to vary a longitudinal distance between the driving structure 141 and the plunger 112 when the mould is at the open position.

In an embodiment, the core 121 includes an inner core 121A, a central core 121B and an outer core 121C. The outer core 121C surrounds the central core 121B which in turn surrounds the inner core 121A. Preferably, the central core 121B and the outer core 121C are attached to each other and movable relative to the inner core 121A along the longitudinal axis A1. The outer core 121B includes a plurality of recesses configured to form an internal thread on the side wall 21 of the cap 2.

The dose 20 is inserted into the mould 1 when the mould 1 is at the open position, that is, when the lower half mould 11 and the upper half mould 12 are spaced apart and the plunger 112 is at the retracted position. After that, there is a step of (partly) closing the mould 1, where the lower half mould 11 and the upper half mould 12 move closer together and delimit the moulding space. The recess R is open onto the moulding space. Closing the mould 1 may cause the dose 20 to be partly compressed.

Preferably, during the movement towards the closed position of the mould 1, the lower half mould 11 moves closer to the upper half mould 12 until a portion of the body 111 of the lower half mould 11 comes into abutment against a corresponding portion of the extractor 122. Next, as the closing movement of the mould 1 continues, the extractor 122 moves relative to the core 121, which remains fixed relative to the extractor 122, from the advanced position to the retracted position, as a result of a thrust of the body 111 of the lower half mould 11. More specifically, the upper half mould 12 comprises an upper elastic assembly 123 configured to connect the extractor 122 to the core 121, which is compressed as the extractor 122 moves from the advanced position to the retracted position.

When the elastic assembly 123 is (partially or totally) compressed, the plunger 112 is moved from the retracted position to the advanced position. This movement reduces the moulding space, since the recess R is occupied by the plunger. Also, the movement of the plunger 112 towards the advanced position causes the dose 20 to be transferred from the recess R to the moulding space until the dose 20 fills the moulding space. More specifically, the lower half mould 11 comprises a lower elastic assembly 113 configured to connect the body 111 to the plunger 112. As the plunger 112 moves from the retracted position to the advanced position, the lower elastic assembly 113 is compressed.

During the movement of the plunger 112, the driving structure 141 moves concurrently with the plunger 112 and the wheel 143 runs along the cam 142 of the drawer 13, causing the drawer 13 to move towards the advanced closed.

Preferably, the lower elastic assembly 113 is more rigid than the upper elastic assembly 123; that way, during the closing movement of the mould, the upper elastic assembly 123 is compressed before the lower elastic assembly 113, that is, the plunger 112 does not reach the advanced position until the relative movement between the extractor 112 and the core 121 has been completed.

Further, the movement of the drawer 13 towards the closed position and the movement of the plunger 112 towards the advanced position are carried out in sequence so that the drawer 13 reaches the closed position before the plunger 112 reaches the advanced position. That way, the plunger 112 completely compresses the dose 20 inside the moulding space only after the drawer 13 has reached the closed position.

In the case where the driving structure 141 is associated with the core 121, the driving structure 141 moves concurrently with the core 121 and the extractor 122 moving relative to each other so that the relative movement between the core 121 and the extractor 122 causes the drawer 13 to move to the closed position when the wheel 143 rolls along the profiled surface of the drawer 13; in this case, too, the drawer 13 reaches the closed position before the plunger 112 reaches the advanced position.

In an example, during the movement of the plunger 112, the driving structure 141 moves concurrently with the plunger 112 and the wheel 143 runs along the cam 142 of the drawer 13, causing the drawer 13 to move towards the closed position.

When compression of the dose 20 in the moulding space has been completed, the upper half mould 12 and the lower half mould 11 move away from each other to the open position of the mould 1. During the opening movement of the mould 1, the extractor 122 can move to the advanced position relative to the core 121. More specifically, the extractor 122 may comprise a retaining portion configured to engage a corresponding portion of the side wall 21 of the cap 2 (that is, the extractor 122 locks the cap 2 by a portion of its side wall 21) so as to disengage it from the core 121.

In an embodiment, the mould 1 comprises a ducting system 16, provided in the lower half mould 11 and configured to allow a cooling fluid to flow in (inside) the lower half mould 11. The ducting system 16 comprises one or more ducts configured to allow a colling fluid to flow.

The ducting system 16 comprises a first duct 161, provided in the body 111. The body 111 comprises a longitudinal portion defining a longitudinal surface 111A contributing to form (at least partly) the external surface of the side wall 21 of the cap 2. The first duct 161 surrounds the moulding space in correspondence of the longitudinal portion of the body 111, so that a refrigerating liquid circulates around the moulding space. The first duct 161 has a delivery duct 161A and a return duct 161B, so that the fluid circulates towards the moulding space in the delivery duct 161A of the first duct 161 with a delivery sense and circulates away from the moulding space in the return duct 161B of the first duct 161, with a return sense opposite to the delivery sense. The ducting system 16 comprises a second duct 162, provided in the plunger 112. The second duct 162 has a delivery duct 162A and a return duct 162B.

In an example, the plunger 112 includes an internal portion 112B (or stem), extending longitudinally, and an external portion 112C, extending cylindrically around the longitudinal axis A1 to partially surround to internal portion 112B. The external portion 112C includes a longitudinally extending portion and a transversely extending portion defining at least partially the transverse surface 112A of the plunger 112. The external portion 112C partially surrounds the internal portion 112B so to form a slot between the external portion 112C and the internal portion 112B.

The delivery duct 162A of the second duct 162 extends at least partially inside the internal portion 112B, inside the slot between the external portion 112C and the internal portion 112B in correspondence of the transversely extending portion and of the longitudinally extending portion. The delivery duct 162A of the second duct 162 extends at least partially inside the base 116 of the lower half mould 11.

The ducting system 16 extends outside the upper half mould 11, through a plurality of external ducts 163 that are configured to put into fluid communication the duct provided in the plunger 112 and in the base 116 with the duct provided in the body 111 (that is the first duct 161 and the second duct 161). The external ducts 163 comprise a delivery duct 163A, connected to the delivery ducts 161A, 162A of the first and of the second duct 161, 162. The external ducts 163 comprise a return duct 163B, connected to the return ducts 161B, 162B of the first and of the second duct 161, 162.

The ducting system 16 has an input end 164, provided in the internal portion 112B of the plunger 112 and configured to feed the ducting system 16 with the refrigerating fluid. The ducting system 16 has an output end 165, provided in the base 116 of the lower half mould 11 and configured to allow the refrigerating liquid to exit. The input end 164 of the ducting system 16 is connected to the delivery duct 162A of the second duct 162 and the output end 165 is connected to the return duct 162B of the second duct 162.

Hence, the delivery duct 162A of the second duct 162 receives the refrigerating fluid from the input end 164; the fluid passes through the delivery duct 162A of the second duct 162, the delivery duct 163A of the external duct 163 and the delivery duct 161A of the first duct 161; then the fluid passes through the return duct 161B of the first duct 161, the return duct 163B of the external duct 163 and the return duct 162B of the second duct 162; in the end the fluid exit the lower half mould 11 through the output end 165.

1. A mould for making a cap for a container by compressing a dose in a moulding space, the mould comprising:
a lower half mould, including a body and a plunger, the plunger being movable relative to the body between a retracted position, where it acts in conjunction with the body to form a recess for receiving the dose, and an advanced position, where it at least partly occupies the recess;
an upper half mould, where the lower half mould and the upper half mould are reciprocally movable along a longitudinal axis between an open position of the mould and a closed position of the mould, where they delimit the moulding space, the recess being open onto the moulding space;
a drawer, movable along a radial direction relative to the longitudinal axis, between a retracted position, distal to the moulding space, and a closed position, proximal to the moulding space, and including a head surface which, at the closed position of the drawer, contributes to delimiting the moulding space;
a movement system, configured to move the drawer along the radial direction,
wherein the movement system is configured to move the drawer from the retracted position to the closed position, responsive to the upper half mould and the lower half mould moving closer to each other.

2. The mould according to claim 1, wherein the movement system includes
a driving structure, movable longitudinally;
a cam and a wheel configured to interact with the cam to move the drawer,
wherein the cam is attached to the drawer and the wheel is connected to the driving structure, or vice versa.

3. The mould according to claim 2, wherein the drawer, the cam and the wheel are associated with the same half mould between the lower half mould and the upper half mould.

4. The mould according to claim 3, wherein the drawer is associated with the body of the lower half mould, the driving structure is fixed to the plunger and, when the drawer is at the closed position, the plunger is at a position between the retracted position and the advanced position.

5. The mould according to claim 4, comprising a plurality of spacers, each removably connected to the plunger and interchangeable with the other spacers to vary a longitudinal distance between the driving structure and the plunger when the mould is at the open position.

6. The mould according to claim 2, wherein the wheel is associated with the driving structure and the drawer comprises a rear surface defining the cam of the movement system.

7. The mould according to claim 2, wherein the movement system is configured to keep the wheel engaged on the cam the whole time the mould is moving between the open position and the closed position.

8. The mould according to claim 1, wherein
the upper half mould comprises a core and an extractor, movable relative to the core between an advanced position and a retracted position, and an upper elastic assembly, configured to connect the extractor to the core and to be compressed when the extractor is at the retracted position;
the lower half mould comprises a lower elastic assembly, configured to connect the body to the plunger and to be compressed when the plunger is at the advanced position,
the lower elastic assembly being more rigid than the upper elastic assembly.

9. The mould according to claim 1, comprising a plurality of drawers, each interchangeable with the other drawers to vary the head surface.

10. The mould according to claim 1, comprising a guide configured to guide the drawer as it runs in the radial direction, and an elastic element, configured to keep the drawer at the retracted position when no other forces are applied to it.

11. The mould according to claim 1, wherein the retracted position and the closed position of the drawer define a start-of-stroke and an end-of-stroke position along the radial direction, respectively, and wherein the start-of-stroke position is variable along the radial direction to vary a distance between the head surface of the drawer, at the closed position, and the moulding space.

12. The mould according to claim 1, comprising a ducting system, configured to allow a cooling fluid to flow inside the lower half mould and extending inside the body and inside the plunger through a duct configured for putting a duct provided inside the plunger and a duct provided inside the body into fluid communication.

13. A compression moulding machine for making caps, comprising a plurality of moulds according to claim 1.

14. A method for making a cap for a container by compressing a dose in a moulding space, the method comprising the following steps:
providing a lower half mould , including a body and a plunger, the plunger being movable relative to the body between a retracted position, where it acts in conjunction with the body to form a recess for receiving the dose, and an advanced position, where it at least partly occupies the recess;
providing an upper half mould, where the lower half mould and the upper half mould are reciprocally movable along a longitudinal axis between an open position of the mould and a closed position of the mould, where they delimit the moulding space, the recess being open onto the moulding space;
providing a drawer, movable along a radial direction relative to the longitudinal axis, between a retracted position, distal to the moulding space, and a closed position, proximal to the moulding space, and including a head surface which, at the closed position of the drawer, contributes to delimiting the moulding space;
closing the mould by moving the upper half mould and the lower half mould close to each other along the longitudinal axis;
moving the drawer from the retracted position to the closed position,
wherein the movement of the drawer is accomplished by a movement system, driven by the movement of the upper half mould and the lower half mould towards each other.

15. The method according to claim 14, wherein the movement system includes a driving structure, movable longitudinally, a cam and a wheel, wherein the cam is attached to the drawer and the wheel is connected to the driving structure, or vice versa, and wherein the step of moving the drawer includes:
moving the driving structure along the longitudinal axis;
interaction between the wheel and the cam to produce the movement of the drawer, responsive to the longitudinal movement of the driving structure.

16. The method according to claim 15, wherein the drawer, the cam and the wheel are associated with the same half mould between the lower half mould and the upper half mould, and the wheel engages the cam the whole time the mould is moving between the open position and the closed position.

17. The method according to claim 16, wherein
the upper half mould includes a core and an extractor, connected to the core by an upper elastic assembly and movable relative to the core between an advanced position and a retracted position;
in the lower half mould, the body is connected to the plunger by a lower elastic assembly;
the movement of the upper half mould and the lower half mould towards each other causes a relative movement between the core and the extractor of the upper half mould and between the body and the plunger of the lower half mould;
one of the following conditions is true:
i) the drawer is slidably coupled to the extractor, and the driving structure connected to the core;
ii) the drawer is slidably coupled to the body and the driving structure is connected to the plunger.

18. The method according to claim 17, wherein:
the relative movement between the extractor and the core of the upper half mould is completed before the relative movement between the body and the plunger of the lower half mould is completed;
the advancing movement of the drawer to the closed position is completed before the relative movement between the body and the plunger of the lower half mould is completed.

19. The mould according to claim 1, wherein the lower half mould defines a lateral portion of the moulding space that forms the external surface of the side wall of the cap, while the drawer contribute, along with the lower half mould, to delimit the moulding space so that the drawer forms a recess or narrow thickness zone in the side wall of the cap, the portion of the lower half mould forming the external surface being stationary along the radial direction.

20. The mould according to claim 2, wherein the drawer comprises a head surface and a rear surface, the rear surface being opposite to the head surface and being configured to define the cam of the movement system, and wherein the head surface develops in a semi-circular shape around the longitudinal axis and in the movement between the retracted position and the closed position, the drawer moves along the radial direction so each point of the head surface moves along a radial direction.
